(19) United States
(12) Patent Application Publication
(10) Pub. No.: US 2011/0313741 A1
(43) Pub. Date: Dec. 22, 2011

(54) METHODOLOGY AND ITS COMPUTATIONAL IMPLEMENTATION FOR QUANTITATIVE FIRST-PRINCIPLES QUANTUM-MECHANICAL PREDICTIONS OF THE STRUCTURES AND PROPERTIES OF MATTER

(75) Inventor: Peter W. Langhoff, San Diego, CA (US)

(73) Assignee: SPECTRAL ASSOCIATES, LLC, Newton, MA (US)

(21) Appl. No.: 13/165,584

(22) Filed: Jun. 21, 2011

Related U.S. Application Data
(60) Provisional application No. 61/356,767, filed on Jun. 21, 2010.

(51) Int. Cl. G06F 17/10

(52) U.S. Cl. 703/2

(57) ABSTRACT

Exact application of the well-known laws of non-relativistic quantum mechanics to the structures and properties of matter leads to equations that are generally too complicated to be soluble. Provided herein are practical methods to overcome these complications in making quantitatively accurate first-principles quantum-mechanical predictions of the structures and properties of forms of matter which are important in a broad range of scientific and technological disciplines.

### CROSS-REFERENCE TO RELATED APPLICATIONS

This application claims priority to U.S. Provisional Patent Application No. 61/356,767, filed Jun. 21, 2010.

### GOVERNMENT FUNDING

This material is based upon work supported by US Air Force Research Laboratory contract FA9300-09-C-2001.

### BACKGROUND

1. Field

The present patent application relates to computational chemistry and physics for material science and related applications.

2. Description of the Related Art

Methods have been developed in an evolutionary fashion over the years for performing first-principles quantum-mechanical calculations of the structures and properties of matter for purposes of guiding and verifying scientific experiments, and for the development of new and improved materials. In their most accurate forms, these methods generally employ large-scale computer-based solutions of the molecular electronic Schrödinger equation, which is known to correctly determine the physical attributes of molecules and materials. Such accurate methods, however, have long been limited by practical considerations to applications involving tens of atoms forming small gas-phase compounds, they require significant resources in the form of highly-trained personnel for software development, and access to computational facilities which can provide large allocations of computer memory, execution times, and related data-storage and -processing capabilities. Consequently, alternative fragment-based, semi-empirical, or empirical approximations have been devised and widely adopted for performing calculations faster and at lower cost, particularly in dealing with material systems involving arbitrarily large numbers of atoms. Unfortunately, such approximate methods, or simulation, are of generally unknowable accuracy in making quantitative predictions of the properties of matter, particularly of as yet unknown forms of molecules and materials for which experimental information is not yet available. Furthermore, different approximate approaches are generally employed for different forms of matter, they generally provide contradictory predictions when applied to the same material systems, and they arguably do not provide the information required to adequately understand the fundamental origins of the nature and attributes of materials. Moreover, predictions based on approximations to the laws of quantum mechanics cannot be employed with confidence in guiding developments in experimental science and applied technology, based as they are on unverifiable ad hoc assumptions. Hence, there is need for highly accurate and reliable first-principles quantum-mechanical methods which are both generally applicable and practical in implementation, and which can converge to unique quantitative predictions for the structures, properties, and transformations of matter in all its forms.

### SUMMARY

Provided herein are methods and systems for making predictions, based on the known laws of quantum mechanics without further approximation, which can be employed with confidence in constructing physical realizations of new and/or modified materials for practical applications in the scientific and technological arts. In an aspect of the invention, the method and its implementation in computational algorithms may direct the operation of digital computers using software programming languages and software compilers, referred to collectively as the computational kernel as described herein. The invention may be incorporated in a computer applications software suite for the purpose of determining the stable spatial arrangements of pre-selected atoms in the ground and/or excited electronic states of atomic aggregates. Such determinations performed making particularly efficient use of the exact pair-wise additive nature of the total electronic energy involving N(N−1)/2 interacting atomic pairs for a system of N atoms, and the analytical nature of the angular variations of these pair-wise electronic energy expressions provided by this disclosure. The invention may be incorporated in a computer applications software suite for the purpose of determining the electronic, magnetic, and other properties of atomic aggregates in stable spatial arrangements in their ground and/or excited electronic states. Such properties may include, but not be limited to, (i) electronic charge distributions, (ii) electronic spin densities, (iii) magnetic susceptibilities, (iv) electric and magnetic shielding factors and nuclear magnetic resonance parameters at all atomic sites, and (v) other ground-state physical properties commonly studied both experimentally and theoretically. The invention may be incorporated in a computer applications software suite for the purpose of determining the electronic, magnetic, and mixed electronic-magnetic multipole transition densities between any two aggregate electronic states obtained from the predictions of the computational kernel for any selected atomic aggregate in not necessarily stable spatial arrangements in the chosen electronic states of the atomic aggregates. Such transition densities may provide, but not be limited to, microwave, infra-red, visible, ultraviolet, and x-ray absorption cross sections and related refractive or dispersive properties including, but not limited to, refractive indices and birefringence in the indicated electromagnetic spectral intervals, and mixed electric-magnetic properties including particularly, but not limited to, circular diachronic and related rotatory dispersion parameters. The invention may be incorporated in a computer applications software suite for the purpose of determining the electronic potential energy surfaces of colliding and/or potentially reacting atomic aggregates, such surfaces to guide the course of the reaction and to determine the yield of the reaction employing commonly employed methodologies for such purposes. Such methodologies may include, but not be limited to, quantum mechanical methods based on time-dependent wave functions to determine the course of collision and/or chemical reactions involving moderately sized organic, inorganic, and other compounds, as well as classical Monte-Carlo and/or Molecular Dynamics simulations used particularly in studies of very large atomic aggregates, including particularly, but not limited to, proteins and other bio-compounds, particularly as relates to the design and development of ligand compounds for use in drug design for therapeutic purposes, nanostructures employed in the fabrication of communications and computing devices, and other such large atomic aggregates. Such determination performed making optimal use of the largely analytical nature of the electronic energy expression provided by the instant computational kernel and the convenient pair-wise-additive natures of the total electronic energy involving N(N−1)/2 interacting atomic pairs for a system of N atoms.

In an aspect of the invention, a method of first-principles quantum-mechanical predictions may include representing the electronic degrees of freedom of matter using an orthonormal outer-product of phase-consistent antisymmetric atomic spectral eigenstates; performing a series of calculations of the required atomic eigenstates, and of their strictly pair-wise additive mutual interactions, wherein the calculations are performed and may be retained for repeated applications; satisfying and enforcing the Pauli Exclusion Principle for predictions of physically acceptable forms of matter; assembling a matrix representation constructed in the orthonormal atomic spectral product representation; and determining the physically significant eigenstates and the related structures and properties of matter required in practical first-principles applications.

In an aspect of the invention, a system for first-principles quantum-mechanical predictions may include a computational kernel comprising interconnected modules that perform separate functions comprising numerical calculations, data processing, data storage and data retrieval as appropriate, wherein the functions are accessed through a graphical user interface and are under the control of a processor; and wherein the kernel provides a spectrum of electronic energies and eigenfunctions in a designated standard form for a given spatial arrangement of selected atoms and ions which make up a molecule or other form of matter. The modules may include one or more of: an Atomic Spectral Module (ASM), an Atomic Interaction Module (AIM), a Hamiltonian Matrix Module (HMM), a Metric Matrix Module (MMM), a Pauli Matrix Module (PMM), and an Eigen Solution Module (ESM).

These and other systems, methods, objects, features, and advantages of the present invention will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The invention and the following detailed description of certain embodiments thereof may be understood by reference to the following figures:

FIG. 1 depicts components and architecture of the computational kernel, which in this embodiment includes six inter-connected modules each of which perform separate functions of data storage and/or calculation as appropriate, all operating under the control of a script-driven main calling computer program.

FIG. 2 depicts components and architecture of a prototypical applications suite, designed in this case to determine the stable or meta-stable structures of a selected combination of neutral atoms and/or ions in one or more chosen electronic states, as well as associated optical absorption cross sections.

FIG. 3 depicts singlet-state potential energy curves dissociating to n=1 and 2 limits in diatomic hydrogen, obtained from full configuration-interaction calculations in an optimized 5s3p2d1f valence basis of Slater orbitals (M. Ben-Nun, J. D. Mills, R. J. Hinde, C. L. Winstead, J. A. Boatz, G. A. Gallup, and P. W. Langhoff, J. Phys. Chem. A 113, 7687 (2009)).

FIG. 4 depicts triplet-state potential energy curves dissociating to n=1 and 2 limits in diatomic hydrogen, obtained from full configuration-interaction calculations in an optimized 5s3p2d1f valence basis of Slater orbitals (M. Ben-Nun, J. D. Mills, R. J. Hinde, C. L. Winstead, J. A. Boatz, G. A. Gallup, and P. W. Langhoff, J. Phys. Chem. A 113, 7687 (2009)).

FIG. 5 depicts potential energy curves for the interaction of aluminum atoms (Al) and ions (Al⁺) with argon atoms (Ar). The calculated AlAr and Al⁺Ar curves are obtained from largely conventional multi-reference configuration-interaction methods, with the ground-state energies of the (²P_{1/2}) Al and (¹S₀) Ar atoms arbitrarily set to zero (J. M. Spotts C.-K. Wong, M. S. Johnson, M. Okumura, J. A. Boatz, R. J. Hinde, J. A. Sheehy, and P. W. Langhoff, J. Phys. Chem. A 107, 6948 (2003)).

FIG. 6 depicts an expanded view of the AlAr potential energy curves of FIG. 5 indicating the weak van der Waals bindings in the ground-state curves and the natures of the highly excited states involved in optical excitations: (a) Ground-state ²Π_{1/2}, ²Π_{3/2}, and ²Σ⁺_{1/2} spin-orbit split curves (solid lines) arising from the ²Π and ²Σ⁺ curves (dashed lines) of FIG. 5; (b) Excited-state 3d and 4p AlAr potential energy curves depicting significant configurational mixing (J. M. Spotts C.-K. Wong, M. S. Johnson, M. Okumura, J. A. Boatz, R. J. Hinde, J. A. Sheehy, and P. W. Langhoff, J. Phys. Chem. A 107, 6948 (2003)).

FIG. 7 depicts calculated equilibrium geometries of icosahedral AlAr₁₂ and Al⁺Ar₁₂ clusters at very low temperatures (T≈10 K) obtained from the lowest cluster energies predicted by an embodiment of the instant computational kernel of FIG. 1 at spatial arrangements selected by a classical Monte Carlo sampling method incorporated in an embodiment of the applications suite of FIG. 2 (J. M. Spotts C.-K. Wong, M. S. Johnson, M. Okumura, J. A. Boatz, R. J. Hinde, J. A. Sheehy, and P. W. Langhoff, J. Phys. Chem. A 107, 6948 (2003)). The black spheres depict the Al atom and its cation.

FIG. 8 depicts the logical sequence of an embodiment of the instant first-principles method of quantum-mechanical predictions.

FIG. 9 depicts the control sequence of an embodiment of the instant first-principles system of quantum-mechanical predictions.

### DETAILED DESCRIPTION

Described herein is a methodology and its computational implementation for making quantitatively accurate first-principles predictions of the structures and properties of normal matter in all its forms for purposes of guiding and verifying scientific experiments and/or fabricating new materials or modifying existing materials for scientific and/or technological purposes. The invention relates to a quantum-mechanical methodology and its algorithmic implementation on digital computers and/or other computing apparatus for obtaining highly accurate solutions of the Schrödinger equation, including its extensions for treatments of magnetic and other non-Coulombic interactions, for practical predictions of physical and chemical quantities measureable in the scientific and technological arts.

The invention combines a number of interlocking physical principles, mathematical theorems, computational algorithms, and data processing and storage/retrieval procedures that may be implemented on digital computers in the form of a computational kernel and of a related series of computer applications suites. The computational kernel may provide quantum predictions orders of magnitude faster and require much less computer memory and data storage than conventional computational methods for such purposes. The particular embodiment described for implementation herein may employ a series of scripts written in Perl, Python, or other scripting languages, in combination with computer directing codes, which together direct and instruct a series of computer source-code subroutines written in Fortran77, Fortran90, C, C++, or other computer programming languages, compiled to be suitably executable code in available computational hardware. The subroutines instructed by scripts and calls carry out numerical calculations that are realizations of algorithms that provide solutions of the aforementioned Schrödinger equation and predictions of measureable quantities on this basis. Although of an entirely mathematical and/or computational nature, said solutions and predictions of the structures and properties of matter are known to be of direct use in the scientific and technological arts. A particular embodiment of the computational kernel is described herein as well as applications suites, which accept and make use of input information calculated by the kernel. In embodiments, the applications suites may be embodied as desktop software, web-based software or tools, software as a service (SaaS), and the like.

Accurate first-principles quantum-mechanical methods as currently practiced in predictions of the structures and properties of matter in its various forms date largely from very early developments, among the earliest such being calculations to confirm the validity of the laws of non-relativistic quantum mechanics for the simple helium atom (He), making particular use of so-called basis-set representations in variational solutions of the non-relativistic Schrödinger equation. Correspondingly early applications of quantum mechanics of a particularly chemical nature were made employing so-called adiabatic electronic wave functions in predictions of the electronic structure of the hydrogen molecule (H2), clarifying thereby the fundamental quantum-mechanical nature of the chemical bond. Related quantum-mechanical calculations of electronic wave functions and energies of bulk solid-state crystalline matter were also formulated in the early days of development of the quantum theory. Additional early applications of quantum mechanics were largely theoretical in nature and limited to model problems, with detailed computational applications hampered by the lack of suitable computational facilities.

The advent of electronic digital computers, generally available beginning in the late 1950's and early 1960's, provided a basis for refinements of electronic structure calculations for molecules and matter which followed closely, or later proved to be related to or essentially identical with, the basic early approaches. Methods commonly employed in constructing electronic wave functions and electronic energy surfaces for molecules and matter include specifically first-principles or “ab initio” quantum chemistry, semi-empirical techniques, including widely employed density-functional methods, hybrid quantum mechanical/molecular mechanical (QM/MM) combinations, fragment-orbital and related methods, and various forms of long-range perturbation theory, to mention some primary representative examples. All such calculations of adiabatic electronic wave functions for molecules and matter more generally being prerequisites for studies of the so-called non-adiabatic dynamical consequences of avoided crossings and conical intersections in the potential energy surfaces that guide the pathways of chemical reactions and other dynamical structural transformations. Such matters being complex in nature but widely understood by those skilled in the art.

The first-principles approaches, which employ so-called multi-configurational Hartree-Fock, Moller-Plessett perturbation theory, configuration-interaction, coupled-cluster, and quantum Monte Carlo approaches can provide highly accurate energies and other properties for the ground and excited states of small molecules, but they generally require allocations of significant computational resources for this purpose, and they are not generally applicable to molecules and materials in the form of large atomic aggregates. These highly accurate methods generally scale in terms of the computational resources required with some power of the size of the system under consideration, such as the number of electrons in the aggregate, they generally are applied to each system studied as a new individual task to be performed, with little assistance in this provided by calculations performed on similar or closely related materials, and they do not lend themselves as presently employed to methods for dividing the calculations into manageable parts. For these and other reasons, applications of first-principle computational methods as currently practiced are not applicable to molecules and materials of arbitrary size and complexity.

Widely employed density-functional, other semi-empirical, fragment-orbital, and QM/MM approaches can be applied to larger aggregates, including atomic clusters, condensed matter, and biological macromolecules, and in certain cases provide electronically excited states, although their a priori accuracy is generally unknown. Moreover, the different available semi-empirical approximations generally provide contradictory quantitative predictions in many cases, different approximation methods are generally employed for different forms of materials (atoms, molecules, crystals, solutions, . . . ), they do not provide a universally applicable approach to the structures and properties of matter, and they cannot give any particular insights into the fundamental origins of the nature of matter, based as they are on ultimately subjective recipes, rather than on applications of the known underlying laws of quantum mechanics.

In contrast to the foregoing conventional computational methods, the instant first-principles methodology and its implementation employs a number of theoretical insights and corresponding mathematical theorems the combination of which provide an entirely new perspective on constructing accurate solutions of the Schrödinger equation (P. W. Langhoff, J. Phys. Chem. 100, 2974 (1996)). Specifically, the instant first-principles methodology employs a spectral product of phase-consistent antisymmetric atomic eigenstates in a formal representational basis for the aggregate electron degrees of freedom of molecules and materials. In this orthonormal representation, there is an absence of explicit or prior term-by-term enforcement of Pauli electron antisymmetry in the individual many-electron atomic product basis functions employed. As a consequence, the system Hamiltonian matrix in the orthonormal aggregate representation is simply additive in pair-wise atomic interaction Hamiltonian matrices, which terms suffice to determine the exact Hamiltonian matrix representative of any atomic aggregate. Such pair-wise interaction Hamiltonian matrices providing faithful representations of the corresponding self-adjoint interaction Hamiltonian operators. In this way, the exact Hamiltonian matrix for every possible atomic aggregate made up of a given set of atoms and ions can be expressed in terms of irreducible atomic and atomic-interaction matrix components which have been calculated once and for all and retained for repeated applications. Aggregate electron antisymmetry is enforced in this approach subsequent to Hamiltonian matrix evaluation employing methods based on theorems that relate to the so-called metric matrices appropriate to the systems under study [P. W. Langhoff, J. A. Boatz, R. J. Hinde, J. A. Sheehy, J. Chem. Phys. 121, 9323 (2004)].

Accordingly, the instant methodology and its implementation avoids treating each molecule or material of interest on an individual basis as a new problem in favor of a once-and-done strategy made possible by the aforementioned alternative approach to representation of electronic degrees of freedom, and to the consequent alternative enforcement of aggregate electron antisymmetry. Although the theoretical insights and theorems employed in this are entirely mathematical or computational in nature, the implementation of these ideas in the form of the computational kernel and applications suites described herein may relate directly to physically realizable circumstances and to practical aspects of the scientific and technological arts. Moreover, the methodology may be applicable in a single general form to molecules, crystals, and complex disordered and extended matter in all its forms, such common form being expected to converge to unique predictions based on the known laws of quantum mechanics in light of the absence of the introduction of subjective ad hoc approximations that can preclude such convergence.

This disclosure provides a practical approach to first-principle quantum-mechanical predictions by combining a series of interlocking elements which include: (i) an atomic-based representation of the electronic degrees of freedom of matter, in which “atomic-based” refers specifically to the use of so-called phase consistent antisymmetric atomic spectral eigenstates in outer-product form in the absence of overall term-by-term aggregate electron antisymmetry; (ii) performance of a series of variational calculations of the required atomic eigenstates, and of their mutual interactions, such calculations performed once and for all and retained for repeated applications, “calculations” referring here in part to conventional constructions of the atomic spectral eigenstates required in the electronic representation and of their mutual atomic interactions; (iii) a method for dealing ex post facto with the so-called Pauli Exclusion Principle, which must be satisfied for predictions of physically acceptable forms of matter; (iv) an integration of components employing methods for assembling and dealing with matrix representations of matter which arise in the course of variational calculations performed employing the atomic spectral-product representation; and (v) methods for determining the physically significant eigenstates and the related structures and properties of matter from the matrix representations which arise in practical first-principles applications.

Potential advantages of the instant first-principles method include: (i) avoidance of the time-consuming repetitive nature of conventional first-principles electronic structure calculations in favor of the indicated series of once and done atomic and atomic-interaction calculations which are retained for repeated applications, resulting in many orders of magnitude faster execution times in the absence of approximations which would result in loss of predictive accuracy, and in significant reductions in attendant personnel and computer resource requirements; (ii) performance of accurate predictive first-principles calculations on significantly larger and more complex forms of matter than is possible using current first-principles means, including predictions of structures and properties of as yet unknown forms of matter; (iii) execution on much smaller computer platforms (desktop vs. supercomputers) at a given level of material size and complexity, resulting in significant comparative reductions in computer hardware and related support requirements; (iv) continuous calibration of the instant first-principles methodology against atomic and atomic-interaction data upon improvements in the state of the experimental and theoretical arts for such determinations; (v) assurance that all predicted values pertain directly to physically realizable and/or measureable quantities in the scientific and technological arts, consequent of the absence of introduction of ad hoc approximations to the laws of quantum mechanics in the instant methodology and its implementation.

In summary, the instant invention relates to computational systems and methods for quantum mechanically-based molecular and materials design and development. The instant invention provides an ab initio QM approach to molecule and materials calculations based on a novel treatment of the Pauli Exclusion Principle, among other attributes. The instant ab initio QM approach may be useful in the design, development, and understanding of chemical and other propellants, energy systems, renewable energy sources, molecular electronics, targeted drug discovery, medical diagnostics, energetic chemical materials and their rates of chemical reaction, aspects of photochemical atmospheric reactions, environmentally related chemical remediation reactions, therapeutic drugs and their interactions with proteins, nano-materials for communications- and computer-related structures, and the like. The instant ab initio QM approach may be embodied in computational applications suites for computer-based design of the structures, properties, and chemical & physical transformations of matter and specific realizations of corresponding prototype systems.

Unless defined otherwise, all technical and scientific terms used herein have the same meaning as is commonly understood by one of skill in the art to which the invention(s) belong. All scientific and technological journals and other publications related thereto, databases, websites and other published materials referred to throughout the entire disclosure herein, unless noted otherwise, are incorporated by reference in their entirety. In the event there is a plurality of definitions for terms herein, or terms in the form of jargon largely unfamiliar to the scientific and technological community are employed in connection with the instant methodology and its implementation, those terms defined in herein prevail. Where reference is made to a URL or other such internet identifier or address, it is understood that such identifiers can change and particular information on the world wide web can come and go, but equivalent information can be found by employing internet search engines. Reference thereto evidences the availability and public dissemination of such information.

As used herein, “first principles predictions” refers to making quantitative predictions on both known and as yet unknown forms of matter in the absence of experimental information other than the well-known charges, masses, and other fundamental attributes of electrons and atomic nuclei, and the values of universal constants, employing the laws of quantum mechanics as appropriate. Such methods, also frequently designated as “ab initio” methods, are ultimately based on solutions of the Schrödinger equation, which equation is known to correctly describe the allowable motions and other attributes of electrons in atoms, molecules, materials and all forms of normal matter more generally. The Schrödinger equation and theory upon which it is based furthermore accounts for the stability of normal matter as due to Coulombic and weaker magnetic interactions between and among electrons and nuclei, and to the effects of the Pauli Exclusion Principle, said equation understood herein to include its extensions for treatments of magnetic and other non-Coulombic interactions. The Schrödinger equation and its solutions and attributes, and the Hamiltonian operators that represent observable quantities in this picture being issues familiar to practitioners of the art. Designations of first-principles approaches which attempt to provide accurate solutions of the Schrödinger equation include so-called multi-configurational Hartree-Fock, Moller-Plessett perturbation theory, configuration-interaction, coupled-cluster, quantum Monte Carlo method, and various forms of long-range perturbation theory, to mention some primary representative examples. Predictions made on basis of solutions of the Schrödinger equation obtained in these ways, although of a mathematical nature, are known to relate directly to the realizable physical and chemical attributes of matter, and thereby provide a basis for practical applications in the scientific and technological arts.

As used herein, “variational methods” refers to those methods for solution of the Schrödinger equation which employ many-electron representational basis sets of various types which are explicit functions of all the coordinates of the electrons in the system, generally resulting in a matrix representation of the Hamiltonian operator of interest which governs the dynamics of electrons in atoms, molecules, and material aggregates. A system of linear equations is generally obtained thereby, solution of which providing system energies as characteristic eigenvalues and associated eigenfunctions represented in the many-electron basis employed. These eigenvalues providing upper bounds on the correct or true energies of the system, such upper bounding eigenvalues converging to the correct values in the limit of a suitably large basis set of representational many-electron functions.

As used herein, “semi-empirical methods” refers to methods for obtaining approximate solutions of the Schrödinger equation that introduce simplifying ad hoc assumptions, and/or parameterizations based upon experimental observations or possibly upon the results of accurate fragment calculations made in particular cases. Classes of these approaches familiar to practitioners of the art include: parameterizations of the so-called Hartree-Fock equations, which refer to an approximate form of the molecular Schrödinger equation; widely used so-called density functional methods, which may, in principle, provide accurate ground-state energies and charge densities, but which require in their accurate forms determinations of largely unknown functionals, and in their implementations are largely one-electron or orbital based approximations; hybrid quantum mechanical/molecular mechanical (QM/MM) combinations which entail explicit quantum-mechanical calculations of small portions of molecules or materials embedded in classical force-model descriptions of larger aggregates; and fragment-orbital and related methods which attempt to break large systems into components which can be treated separately on an individual basis and combined to make an approximate whole.

As used herein, “structures”, or “chemical structures”, or “equilibrium structures” refer to the stable and/or meta-stable geometrical spatial arrangements of atoms, or of atoms in units cells or other repeating subunits, as appropriate, which comprise matter, such as amino acids in proteins or nucleotides in RNA and DNA chains, recognizing the underlying uncertainties in atomic/ionic positions associated with irreducible vibrational motions. Such structures determined from variational solutions of the Schrödinger equation by finding the atomic spatial arrangements associated with the lowest possible energies of systems, which arrangements can be obtained in many ways, including use of so-called Monte-Carlo sampling algorithms to select the lowest energy structures from a great many trial aggregate spatial configurations. In so far as such predictions are based on accurate solutions of the Schrödinger equation they can be expected to conform to experimental circumstances and can accordingly provide a basis for practical applications in the scientific and technological arts.

As used herein, “electronic structure” refers to quantitative descriptions of electrons in an atom, molecule, or material aggregate as specified by the complete spectrum of eigenenergies and eigenstates that characterize the system and determine its response to external static or dynamic stimulation, including but not limited to electromagnetic fields, colliding changed or neutral particles, interacting chemical species, and related disturbances. In determining the system electronic properties and responses, the eigenspectrum of electronic energies and states are generally employed in evaluating so-called expectation values of the quantum mechanical operators which specify the measurement process or disturbance, in which connection the time evolution of the system due to an external disturbance may be required. The latter being determined by solution of the time-dependent Schrödinger equation, which solution can be constructed employing the system eigenspectrum as a representational basis.

As used herein, “properties” refers to the physical and/or chemical attributes of ordinary matter, such as the mechanical, thermal, electric, magnetic, and other conventional largely static attributes of the stable and meta-stable forms of ordinary matter as commonly understood, as well as to the chemical and photochemical reactivities, electromagnetic spectra, and other largely dynamical attributes commonly associated with both ground and electronically excited and ionized states of matter. Such properties being subject to experimental determinations by measurement employing suitable technologies, and to predictions made employing the electronic structure and other attributes of the system in question as determined on basis of accurate solutions of the controlling Schrödinger equation.

As used herein, “atomic spectral eigenstates”, or “phase-consistent antisymmetric atomic eigenstates” refer to quantum-mechanically determined atomic eigenstates in real or complex forms that represent the electronic degrees of freedom of an atom or ion and determine the corresponding energy eigenvalues, the degenerate components of such atomic states satisfying mutual phase relations that insure they transform correctly under coordinate system rotations and possibly other transformations. The effects of coordinate system rotations being commonly implemented employing so-called Wigner rotation matrices for this purpose. Such phase-consistent states as obtained from solution of the atomic Schrödinger equation may include the effects of the Pauli Principle and of Coulombic interactions, and may also incorporate magnetic interactions, appropriate quantum numbers, providing complete specifications of the relevant degeneracies in each case following standard atomic spectroscopic notation or usage. The energies associated with atomic/ionic states, as obtained from experimental measurements, being generally available in the form of open-source scientific tabulations for comparisons with predictions of first-principles calculations.

As used herein, “spectral-product representation” or “atomic spectral-product representation” refer to use of the aforementioned electronic spectral eigenstates of atoms and/or their ions in an orthonormal outer-product form for descriptions of the electronic degrees of freedom of material aggregates of matter. Such representation made in the absence of explicit term-by-term prior enforcement of aggregate electron antisymmetry of the individual product terms employed in the representation (P. W. Langhoff, J. Phys. Chem. 100, 2974 (1996)). This particular representation being known to span both totally antisymmetric, and selected non-totally antisymmetric, irreducible representation of the aggregate electron symmetric group, special methods being required in its applications in constructing variational solutions of the Schrödinger equation (P. W. Langhoff, J. A. Boatz, R. J. Hinde, J. A. Sheehy, J. Chem. Phys. 121, 9323 (2004)).

As used herein, “Pauli electron antisymmetry”, or “Pauli Exclusion Principle”, or “Pauli states” refer to the requirement that physically acceptable solutions of the Schrödinger equation transform under electron spin and space coordinate permutations according to the totally antisymmetric irreducible representation of the symmetric group for aggregate electrons. Correspondingly, “non-Pauli states” or “non-Pauli solutions” refer to solutions of the many-electron Schrödinger equation that transform under electron spin and space coordinate permutations according to any but the totally antisymmetric irreducible representation of the symmetric group for aggregate electrons.

As used herein, “valence-bond methods” or “valence-bond theory” refer to any of a large number of computational methods for determining atomic and molecular electronic structures which have in common the use of products of atomic orbitals in the descriptions of the electronic degrees of freedom of molecules and other aggregates. In the instant invention, the many-electron basis functions generally but not always employed in such calculations are commonly designated as standard tableau functions in the jargon of the theory, and are generally but not always constructed in a set of so-called real one-electron Slater spatial orbitals which are optimized for descriptions of the atomic/ionic spectral states employing conventional methods familiar to practitioners of the art. Use of very large numbers of such standard tableau functions being designated as “configuration interaction” in recognition of individual such functions describing a particular spatial and spin configuration of a product of electron orbitals, implying thereby the accommodation of the mutual interactions of distinct configurations of electronic charge.

As used herein, “Slater orbital” or “Slater-type orbital” or “Slater basis set” refer to any or all of a set of single-valued scalar functions of a single coordinate, referred to as a “radial coordinate” (r), in which there is a product of an exponential term, which decreases in value with increasing r, with a positive-integer power of the radial coordinate, which increases in value with increasing r, such Slater function or orbital possibly “normalized” to contain unit area under its square value integrated over all values of the coordinate r. Typical forms having designations familiar to those skilled in the art, including; optimized valence basis set; Strumian basis set; and even-tempered Slater basis set, to mention some representative examples.

As used herein, “diatomic calculations” refers to the process of obtaining ground and excited-state solutions of the electronic Schrödinger equation for a pair of atoms separated by some arbitrary distance (R) employing valence-bond and variational methods or other first-principles approaches for this purpose. The calculations made in the instant invention employing the same many-electron basis sets as are employed in calculations on the two subject atoms, providing diatomic energies and states which are in accord with molecular spectroscopic spin and space designations for diatomic molecules, making use of commonly employed finite spatial point-group or continuous rotation group symmetry reductions of the diatomic spatial symmetry states when convenient or required.

As used herein, “metric matrix” or “aggregate metric matrix” refer to the many electron overlap matrix of the explicitly antisymmetrized atomic spectral-product basis, or, equivalently, to within a constant factor, to the expectation value of the so-called aggregate electron antisymmetrizer evaluated in the orthonormal atomic spectral-product representation. Such matrix providing a universal method to discriminate among Pauli and non-Pauli states or solutions of the Schrödinger equation obtained in the spectral-product representation, and accordingly to isolate thereby the former for computational purposes (P. W. Langhoff, J. A. Boatz, R. J. Hinde, and J. A. Sheehy, “Applications of Lowdin's Metric Matrix: Atomic Spectral Methods for Electronic Structure Calculations,” in Erkki Brandas and Eugene S. Kryachko (Eds.) Fundamental World of Quantum Chemistry: A Tribute to the Memory of Per-Olov Löwdin (Kluwer Academic, Dordrecht, 2004), Volume 3, pp. 97-114).

As used herein, “spectral compression” or “Stieltjes compression” refer to a reduction in the number of one-electron orbitals used in construction of atomic eigenstates, or of the number of phase-consistent antisymmetric atomic eigenstates employed in a spectral-product representation, such reduction done atom-by-atom, and/or also on the entire spectral product in a manner to ensure that little or no loss in spectral completeness is introduced in the reduction process. Such reduction performed for purposes of constructing solutions of the Schrödinger equation in the spectral-product representation employing variational methodologies in an optimal manor (P. W. Langhoff, “Stieltjes Methods for Schrödinger Spectra: Hilbert-Space Approximations to the Discrete and Continuum Eigenstates of Spatially Anisotropic Hamiltonian Operators,” in Mathematical Frontiers in Computational Chemical Physics, D. G. Truhlar, Editor (Springer, Berlin, 1988), pp. 85-135).

As used herein, “odometer ordering” refers to a labeling scheme for the sequential ordering in a row vector of the products of atomic functions which make up a spectral-product representation of many-electron basis states, in which scheme the individual indices enumerating the eigenstates of the last, next-to-last, and so on to the first atom appearing in the product terms are varied over their full ranges of values before those of the earlier atoms appearing in the product sequence (P. W. Langhoff, J. Phys. Chem. 100, 2974 (1996)). Such ordering of spectral-product functions implying a corresponding ordering of the elements of Hamiltonian, metric, and other matrices constructed in this representation, generally indicated by a suitable notation, such as the use of a subscript “O” on such ordered matrices.

As used herein, “computational module” refers to a combination of computer or computational hardware, including related peripheral equipment and data storage and transfer devices, and computational software, including instructions written employing scripting and programming languages that provide machine-readable computer executable code upon processing by a suitable source-code compiler. Such combination operating under the control of a set of script-enabled instructions for the purposes in the instant methodology of directing subroutines that perform particular mathematical operations in expressing numerical and other algorithms for predictions of quantities associated with solutions of the Schrödinger equation.

As used herein, “computational hardware” refers to a great variety of largely digital, but also graphical, computing engines that are commonly available in scientific and technological settings, and refers also to associated peripheral equipment. Such digital computing engines including stand-alone workstations having one or more CPUs or GPUs and associated peripheral equipment, clusters of such units operating together through switching and data transfer apparatus for input/output (I/O) communications purposes, and/or individual nodes hosting one or more CPUs or GPUs in a parallel computing arrangement, all capable of performing computations of various types when so enabled by executable computer software. Peripheral equipment including particularly data storage devices such as a cache internal to a CPU or GPU, a disk storage system internal or external to a CPU or GPU, or a large data-file-transfer server, to mention some representative examples.

As used herein, “computational software” refers to any or all forms of methods for providing instructions to a computer, including scripting languages such as Perl, Python, or others used in controlling, directing, and instructing an executing computer code, data transfer, or other sequences of I/O operations, and other such operations more generally, programming languages such as Fortran77, Fortran90, C, C++, and others used in devising on a computer-readable medium a source program of instructions for directing the operations of a computer through use of a compiler that provides an executable code, and applications programming-interface languages that support programming languages directing multi-platform shared-memory processors.

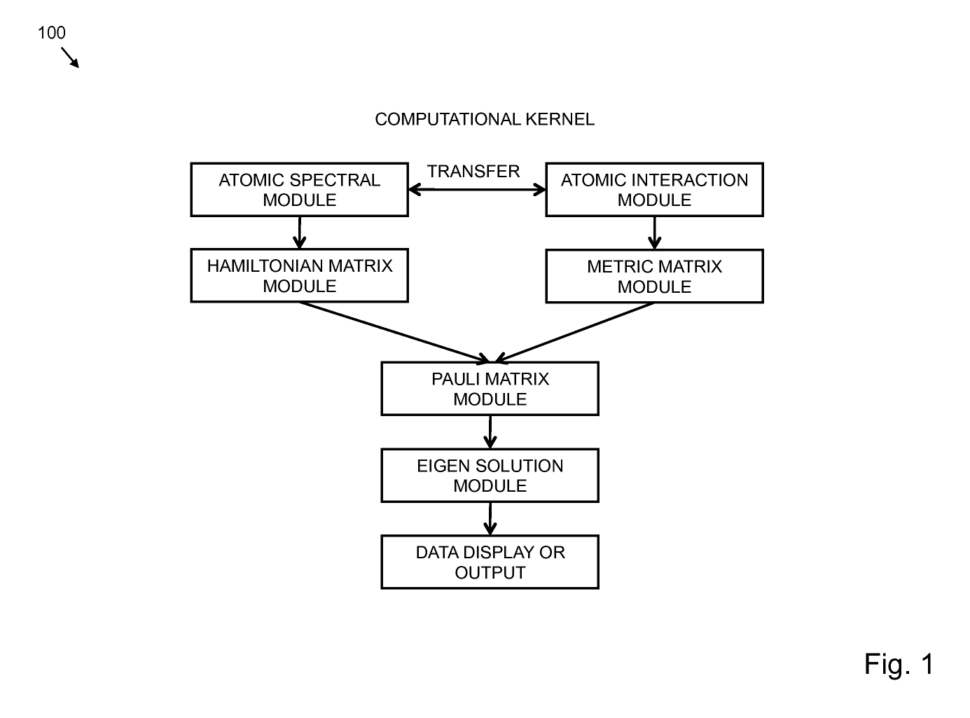

Referring now to FIG. 1, a particular embodiment of the components and workflow of the computational kernel central to the instant methodology and its implementation is depicted. As indicated, the kernel may include one or more inter-connected modules each of which may perform separate functions, including numerical calculations, data processing, and data storage and retrieval as appropriate. These functions may be accessed through a graphical user interface and may be under the control of a central processing unit (CPU) or graphical processing unit (GPU) directed by a Perl, Python, or other script-driven computer sequence which instructs computational subroutines written in Fortran77, Fortran90, C, C++ or other programming languages, appropriately compiled in the form of programs executable in computer hardware. The natures and functions of these individual modules, and of their collective operation as a computational kernel, are described in further detail herein. The kernel may provide a spectrum of electronic energies and eigenfunctions in a designated standard form for a given spatial arrangement of selected atoms and ions that make up a molecule or other form of matter. In embodiments, the individual units or modules of the kernel may be given descriptive abbreviations for convenient reference, (a) ASM—Atomic Spectral Module; (b) AIM—Atomic Interaction Module; (c) HMM—Hamiltonian Matrix Module; (d) MMM—Metric Matrix Module; (e) PMM—Pauli Matrix Module; (f) ESM—Eigen Solution Module. The computational workflow within each of the kernel modules in FIG. 1 may be as described in the sequel.

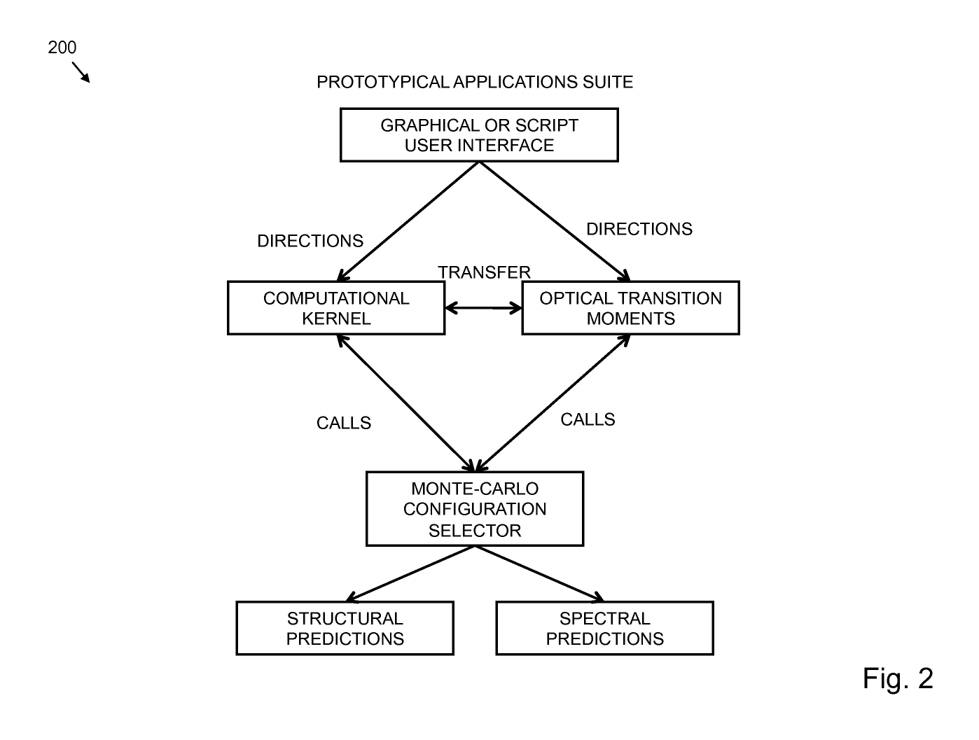

The kernel may be designed to perform two distinct but closely related functions: (i) It may operate in a first-principles data calculational and storage mode, in which mode selected atomic, atomic-pair interaction, and related data may be generated and stored for later use; (ii) It may be called upon in the form of a computer subroutine as part of an applications suite designed to perform a series of first-principles calculations required in predicting particular properties of molecules and materials, as depicted in the prototype example of FIG. 2. When performing as a subroutine in FIG. 2, the kernel may provide specifically a selected number of electronic eigenstates and eigenenergies of material aggregates of chosen atoms and/or ions in specified spatial arrangements by performing all the tasks of FIG. 1. When performing in the first-principles data-generating mode, the kernel may be under the control of a graphical user interface and a script-driven sequence of instructions to employ selected portions of or all of the workflow and tasks of FIG. 1.

The kernel may accomplish the foregoing functions by incorporating one or more interlocking modules in a main calling program which may direct computational hardware and/or data storage units in performing specific computational and/or data processing, management, and transfer tasks, as indicated in FIG. 1. The main calling program may employ one or more computer scripting (Pearl, Python, . . . ) and/or programming (Fortran77, Fortran90, C, C++, . . . ) languages which direct a number of computational software subroutines, the latter being source codes written in one or more software languages, or taken from public domain open-source coding libraries, or from software copyrighted under a public licensing arrangement, such as a GNU General Public License, and modified for the instant purposes, such modifications being of a greater or lesser extent as required. The scripts and source codes that control the operation of the kernel may implement the scientific ideas, mathematical theorems, and computational algorithms inherent in the instant methodology in both the data-generating mode and/or in its operation as a computational kernel in an applications suite. The first-principles data generated by the kernel, or by a computational suite employing the kernel, may be directly comparable to corresponding experimentally measureable values, and, accordingly, may be employed in guiding and interpreting scientific laboratory experiments and/or in developing new and/or improved forms of molecules and materials.

The Atomic Spectral Module (ASM) may be a computer-script/language-directed atomic eigenstate and energy data generating, processing, and storage module that performs first-principles calculations of atomic and ionic energies and their phase consistent antisymmetric eigenstates employing configuration-interaction and other algorithms, and computer code subroutines designed for this purpose. The ASM may store this information for transfer to other modules for predictive purposes on request, and may compare calculated values with available experimental data. A particular embodiment of the ASM may include its operation as either an atomic data storage and access module or as a computational module that calculates and stores first-principles atomic data and corresponding experimentally determined data. In the storage/access mode, the ASM may provide data upon computer driven request acting as a component of the computational kernel of FIG. 1. When operating in the atomic data generation and storage mode, the ASM may calculates first-principles atomic data under the control of a graphical user interface and Perl, Python, or other script-driven directions which instruct computational subroutines written in Fortran77, Fortran90, C, C++ or other programming languages, appropriately compiled in the form of programs executable in computer hardware. In the storage/access mode the ASM may provide data upon script driven request acting as a component of the computational kernel of FIG. 1.

The Atomic Interaction Module (AIM) may be a computer-script/language-directed atomic interaction data calculation and storage module which may perform first-principles calculations of the mutual pair interactions of atoms and/or their ions in a manner complementary to and consistent with the aforementioned phase consistent antisymmetric atomic eigenstate calculations employing configuration-interaction and other algorithms, and computer code subroutines designed for this purpose. The AIM may store this information and transfer it to other modules for predictive purposes on request. A particular embodiment of the AIM may show its operation as either an atomic-interaction data storage and access module or as a computational module that calculates and stores first-principles atomic-interaction data. In the storage/access mode, the AIM may provide data upon computer driven request acting as a component of the computational kernel of FIG. 1. When operating in the atomic-interaction data generation and storage mode, the AIM may calculate atomic-interaction data under the control of a graphical user interface and Perl, Python, or other script-driven directions which instruct computational subroutines written in Fortran77, Fortran90, C, C++ or other programming languages, appropriately compiled in the form of programs executable in computer hardware.

The Hamiltonian Matrix Module (HMM) may be a computer-script/language-directed module that implements mathematical/numerical algorithms for construction of pair-wise-atomic Hamiltonian matrices constructed in an orthonormal atomic spectral-product representation from component atomic and atomic-interaction information provided upon request by the ASM and AIM. A particular embodiment of the HMM may show its operations in assembling Hamiltonian matrices for specified aggregates of atoms and/or ions from first-principles atomic and atomic-interaction data stored in the ASM and AIM, operating in conjunction with the MMM and PMM. The HMM may operate under the control of Perl, Python, or other script-driven directions which instruct computational subroutines written in Fortran77, Fortran90, C, C++ or other programming languages, appropriately compiled in the form of programs executable in computer hardware.

The Metric Matrix Module (MMM) may be a computer-script/language-directed module that performs calculations of so-called metric matrices required in the enforcement of aggregate electron antisymmetry in the spectral-product representation, employing computer software subroutines devised for this purpose. A particular embodiment of the MMM may show its operations as a computational module for calculating aggregate metric matrices employing first-principles atomic data stored in the ASM, as required in enforcing the Pauli exclusion principle in obtaining first-principles solutions of the Schrödinger equation in the instant methodology. The MMM may operate under the control of Perl, Python, or other script-driven directions that instruct computational subroutines written in Fortran77, Fortran90, C, C++ or other programming languages, appropriately compiled in the form of programs executable in computer hardware.

The Pauli Matrix Module (PMM) may be a computer-script/language-directed module that may execute methods for enforcing the Pauli exclusion principle on the pairwise-additive aggregate Hamiltonian matrix assembled from individual atomic-pair interactions in the HMM by matrix transformation employing input from the MMM and HMM, and computer software subroutines devised for this purpose. A particular embodiment of the PMM may show its operation in calculations of matrices for transformation of the aggregate Hamiltonian matrix provided by the HMM from the spectral-product representation to a corresponding totally antisymmetric orthonormal representation. The PMM may construct the required transformation matrices employing the eigenvalues and eigenvectors of metric matrices provided by the MMM, operating under the control of Perl, Python, or other script-driven directions which instruct computational subroutines written in Fortran77, Fortran90, C, C++ or other programming languages, appropriately compiled in the form of programs executable in computer hardware.

The Eigen Solution Module (ESM) may be a computer-script/language-directed module that may implement methods for determining the physical eigenstates of the Pauli-exclusion-principle corrected aggregate Hamiltonian matrix employing information from the PMM and computer software subroutines devised for this purpose. A particular embodiment of the ESM may show its operation as a matrix eigenvalue/eigenvector solver in obtaining first-principles solutions of the Schrödinger equation, as represented in the instant methodology in either the spectral product basis as obtained from the HMM, or in a totally antisymmetric subspace thereof obtained from the PMM. The ESM may operate under the control of Perl, Python, or other script-driven directions which instruct computational subroutines written in Fortran77, Fortran90, C, C++ or other programming languages, appropriately compiled in the form of programs executable in computer hardware, and may incorporate modern computer library utilities (BLAS/LAPACK, PETSc/SLEPc) in its operation.

The modules of the kernel of FIG. 1 may pass information among themselves and otherwise communicate by script/language-driven instructions, or user request, for specific purposes employing a common data interface or related methodology under the direction of the overall main calling program. The algorithmic architecture and inner workings of the modules may be largely fixed over extended periods, although they may be updated from time to time to accommodate improvements in programming languages, source code compilers, and computer utilities libraries, and in the data stored in files internal to the modules. Additionally, as improved and alternative computational hardware becomes available, the algorithms on which the kernel's methodology is based may be accordingly revised. The kernel may operate in a single pass mode as a stand-alone computational resource, in which output electronic structure data produced is stored and/or employed in various connections, or it may be called repeatedly as a subroutine in one or more applications suites. The tasks performed by the kernel modules and the data provided thereby may be common to a number of applications suites as described herein.

The purpose of the ASM may be more specifically to calculate atomic and ionic eigenstates and energy eigenvalues employing first-principles quantum-mechanical methodologies devised for these purposes, to insure these are phase-consistent atomic and ionic eigenstates suitable for arbitrary rotations of the spatial coordinate frame that describes the positions of atoms in a chemical aggregate, to store these data in a computer file-storage device, and to provide such data as output for display or to other modules in the computational kernel upon script-driven or other instruction. In a particular embodiment, the workflow of the ASM may be divided into a series of individual tasks. The individual controlling computer code may employ one or more computer scripting languages (Pearl, Python, . . . ) in providing instructions to a number of computer software subroutines. The latter may be complied versions of computer source codes written in one or more software languages (Fortran77, Fortran90, C, C++, . . . ) explicitly for the instant purposes, and/or taken from public domain open-source coding libraries, and/or from software copyrighted under a public licensing arrangement, such as a GNU General Public License, and modified for the instant purposes. Extensive use may be made in the ASM of selected computer subroutines written in C code contained in generally available computational suites (CRUNCH) devised by those skilled in the arts of electronic structure calculations. In cases of operation of the ASM on parallel computing hardware, OpenMP calls may be employed to access efficiently the multiple CPU's associated with the individual computer nodes provided. The scripts that control the operation of the ASM may implement the theoretical ideas, mathematical theorems, and computational algorithms inherent in the ASM, and instruct the aforementioned computer source codes modified for the instant purposes. The data generated by the ASM, which may be entirely of a mathematical nature, may be directly comparable to corresponding experimentally measureable values, and, accordingly, may be employed as obtained from both its stand-alone operation and its use as part of the computational kernel of FIG. 1 in guiding and interpreting laboratory experiments, and/or in developing new and/or improved forms of molecules and materials. Particular embodiments of the individual computational modules of the ASM are more specifically described as follows.

A basis Set Repository of the ASM may be a module in the form of a data storage unit containing files for a number of distinct sets of so-called Slater-type atomic-orbital basis sets, including Rydberg extended optimized valence basis sets, Strumian extended valence basis sets, and even-tempered Slater-orbital basis sets, to mention some examples. The particular forms of these orbital basis sets may be determined by a series of first-principles calculations performed employing the ASM in determinations of the spectral energies and eigenfunctions of atoms/ions of interest, including calculations of ground-states, valence-excited states, low-lying Rydberg states, and pseudo-state representations of sums of high-lying Rydberg states and low-lying continuum states. Methods familiar to practitioners of the art may be employed to evaluate the spectral closure afforded by specific basis sets devised, and iterative procedures employed to converge upon values judged to be satisfactory for the instant purposes. The particular radial coordinate powers, exponents, values of orbital angular momenta, and dimension of the representations devised in each case may be of significant value and accordingly not disclosed. In selected cases, the Slater basis sets devised may be spectrally compressed to provided one-electron representations of reduced dimensions which have optimally spaced energies and which satisfy the closure conditions employed in evaluations of the un-compressed basis set.

An Integral Evaluation and Storage module of the ASM may be a module which calculates and stores so-called one and two-electron integrals over the chosen Slater basis functions employing available computer subroutines adopted from the aforementioned computational code suite (CRUNCH), as modified for the instant purposes. These subroutines may implement largely standard numerical atomic algorithms that are known to provide accurate values for the desired integrals. The one- and two-electron integrals evaluated include kinetic energy, electron nuclear attraction, electron-electron repulsion, and Slater-orbital overlap integrals, all of which may be required in performing electronic structure calculations for atoms and ions. The integrals may be labeled and stored in a manner useful for expediting their retrieval by calls from other modules in the ASM. The value of the integrals resides in the fact of their construction in the particular Slater orbital basis sets employed, which basis sets provide representations of the entire aforementioned range of atomic spectral states upon which the instant methodology and its implementation depends.

A SCF Configuration Generator of the ASM may be a module that constructs a set of orthonormal self-consistent field (SCF) or Hartree-Fock orbitals employing the aforementioned Slater basis sets for an atom/ion. The module may generate from these orbitals a specified set of many-electron basis functions commonly designated as standard tableau functions in the jargon of the valence-bond theory of atomic and molecular electronic structure, and familiar to those skilled in the arts of electronic structure calculations. These functions may be devised to have particular spin values that relate to the possible spin states known to occur in the atom or ion under consideration, and also to incorporate the effects of the Pauli exclusion principle as they relate to atomic structure determinations. The SCF standard tableau function may be labeled in machine and human readable forms and may be stored for retrieval by other modules in the ASM for purposes of further calculations. Such basis sets of many-electron functions having specific atomic spin values may be employed in variational calculations of the appropriate atomic Schrödinger equation expressing the laws of quantum mechanics.

An Atomic Matrix Generator of the ASM may be a module that constructs kinetic energy, electron-nuclear potential energy, electron-electron repulsion energy, and overlap matrices in the chosen set of many-electron SCF standard tableau functions of specific spin type indicated in the foregoing. Such constructions may be made employing available computer subroutines adopted from the aforementioned computational code suite (CRUNCH), as modified for the instant purposes. The three indicated energy matrices together may provide the Hamiltonian matrix, and the overlap matrix of the SCF standard tableau functions, which may both be required in solution of the generally non-orthogonal atomic Schrödinger equation which results from employing variational methods in the SCF standard tableau representation.

An Eigensolver/Processor of the ASM may be a module which constructs variational solutions of the atomic Schrödinger equation from the assembled Hamiltonian and overlap matrices employing matrix decomposition, inversion, and diagonalization routines adopted from available sources (CRUNCH), modified to improve performance of these as appropriate, such modifications referring largely but not only to introduction of modern computer library utilities (BLAS/LAPACK, PETSc/SLEPc). The atomic/ionic eigenfunctions obtained may be described by elements of a transformation matrix that specifies the contributions to given atomic/ionic eigenfunction of elements of the basis of many-electron standard tableau functions employed. The transformation matrix, the associated energies, and other relevant information may be tabulated in standard formats for subsequent data access. Phase or sign consistency of the degenerate components of a given atomic/ionic eigenfunction may be assured by use of so-called angular momentum ladder or step operators following methods not disclosed, or by appropriate modification of the relevant transformation matrix elements which pertain to the atomic/ionic states considered, if required. The processed and stored phase-consistent atomic/ionic eigenstates suitable for arbitrary rotations of the coordinate frame, and the associated atomic/ionic energies and other information, may be described by a descriptor file for each atom or ion, which file includes specification of the numbers and types of eigenstates contained in the data storage unit employing common spectroscopic notation and degeneracy enumeration. The positions of these atomic/ionic eigenstates in a sequentially ordered row vector may also be stored following a specific ordering scheme for each atom or ion. The transformation matrix and specification of the basis functions employed, including the orbital exponents and powers of radial coordinates in the one-electron Slater basis sets used in forming the many-electron standard tableau functions, may be included in the atomic descriptor file for the individual atoms and ions in the ASM. The phase-consistent many-electron atomic eigenspectra in some cases may be compressed employing methods previously devised for this purpose.

The ASM may transfer the stored atomic energies, phase-consistent atomic/ionic eigenstates, and related information upon computer-driven request to subsequent modules in the computational kernel of FIG. 1, which may perform additional calculations and assembly of quantities of interest, such assembly referring largely but not entirely to formation of certain energy, property and metric matrices. Calculations on additional atoms not previously treated may be made on a continuing basis and stored for subsequent use, as may be refinements in the data already stored as the computational methodology for such purposes shows noticeable improvements, and the possibility of generating more accurate and larger data sets presents itself. These results may be compared from time to time with updates in corresponding experimental values of spectroscopic energies, which may also be stored in the ASM. Although the computer architecture of the ASM may be fixed at the outset, improvements in its performance may be made from time to time as both hardware and software refinements become available.

Table 1 depicts a ground-state energy E(au) and excited-state term ΔE(eV) values in atomic boron obtained from a particular embodiment of the instant ASM for the indicated eight n=2 valence states.

TABLE 1
Valence States in Atomic Boron.^{a}

| State | Mutliplet Representation^{b} | FCI^{c} | Experiment |
|---|---|---|---|
| (2s²2p)²P^{o} | −24.56 | −24.60/−24.60 | −24.65 |
| (2s2p²)⁴P^{e} | 3.05 | 3.58/3.51 | 3.58 |
| (2s2p²)²D^{e} | 6.77 | 5.99/6.02 | 5.93 |
| (2s2p²)²S^{e} | 8.63 | 7.86/7.82 | 7.88 |
| (2s2p²)²P^{e} | 10.48 | 9.04/— | 8.99 |
| (2p³)⁴S^{o} | 11.77 | 12.11/— | 12.03 |
| (2p³)²D^{o} | 13.62 | 11.95/— | 12.37 |
| (2p³)²P^{o} | 15.69 | 13.84/— | 13.77 |

^{a}Ground-state energy E(au) and excited-state term ΔE(eV) values obtained for the indicated eight n = 2 valence states in atomic boron.
^{b}Results obtained using all states arising from 2p³, 2s2p², and 2s²2p multiplet configurations.
^{c}Full calculations obtained using all ground-state HF excitations of the 1s²2s²2p configuration keeping the 1s² shell closed, the second set of values including Rydberg-valence interactions.

In Table 2 are shown such values for selected Rydberg series in atomic boron. The discrepancy between the calculated and experimental ground state energy of ≈0.01 au, as well as other small discrepancies between theory and experiment for the valence and Rydberg states, is due to the neglect of core-shell and relativistic corrections to the calculations.

TABLE 2
Rydberg States in Atomic Boron.^{a}

| n | (ns)²S^{e} Series^{b} | (np)²P^{o} Series^{b} | (nd)²D^{e} Series^{b} | (nf)²F^{o} Series^{b} |
|---|---|---|---|---|
| 3 | 4.964/4.949 | 6.027/6.013 | 6.790/6.801 | —/— |
| 4 | 6.820/6.806 | 7.165/7.152 | 7.438/7.445 | 7.443/7.582 |
| 5 | 7.457/7.459 | —/7.625 | 7.747/7.760 | 7.751/7.888 |
| 6 | 7.747/7.790 | —/7.889 | 7.916/7.963 | 7.918/8.054 |
| 7 | 7.954/8.031 | —/8.049 | 8.018/8.090 | 8.019/8.155 |
| 8 | 8.033/8.113 | —/8.145 | 8.084/8.165 | 8.298/8.221 |
| 9 | —/8.181 | —/8.203 | —/8.271 | —/8.301 |
| 10 | —/8.218 | —/8.220 | —/8.312 | —/8.331 |
| IP | 8.298 | 8.298 | 8.298 | 8.298 |

^{a}Experimental/theoretical term values ΔE(eV) obtained for the indicated ns, np, nd Rydberg states in atomic boron converging on the B⁺ ionic state [(1s²2s²)¹S^{e}-8.298 eV].
^{b}The theoretical values are obtained from single and double excitation calculations employing (45s, 45p, 45d) even tempered basis sets.

Referring to Tables 1 and 2, an illustration of a particular embodiment of the ASM shows experimental spectral energies of atomic boron in comparison with corresponding values calculated employing Slater-orbital basis sets and both small and larger numbers of tableau functions. The two sets of calculated values refer to results obtained in a minimal theory, the so-called multiplet approximation, and to values obtained from a more complete representation, or essentially converged configuration-interaction representation. Those skilled in the arts of electronic structure calculations will realize that the calculations exhibit convergence to the experimental values, and also provide the atomic eigenfunctions which may be associated with the reported energies—whereas the energies may be directly measureable and can be compared with the calculated values, the atomic eigenfunctions, which ultimately determine the chemical and physical attributes of atoms and ions, may be largely measureable only indirectly through such properties as energies, charge densities and other data that may be calculated in predictions of physical properties.

The purpose of the AIM in FIG. 1 may be to calculate atomic-pair interaction-energy matrix elements and related information employing computational methodologies devised for these proposes, as implemented in the form of computer software subroutines, to process these data in a manner corresponding to construction of pair-interaction Hamiltonian and metric matrices in the atomic spectral-product representation, to store these data in particular formats in a computer file-storage device, and to provide such data upon computer-driven request to other modules in the kernel. The atomic-interaction data files may contain information pertaining specifically to the ground- and excited-state electronic energies and eigenfunctions of the diatomic pairs that dissociate into the atomic and/or ionic states stored in the ASM. The pair-interaction data calculated and stored as diatomic Hamiltonian, metric, and transformation matrices may be calculated over a pre-selected range and grid of interatomic separations (R) and employed repeatedly in practical applications of the instant methodology.

Atomic pair-interaction matrices may be obtained from diatomic calculations made by the AIM in antisymmetrized outer products of the same many-electron basis sets as are employed in the aforementioned atomic calculations employing so-called valence-bond representations. The many-electron atomic-interaction integrals required in this connection may be evaluated employing subroutines taken from available code suites (SMILES) devised for the evaluation of such terms in Slater orbitals basis sets, modified extensively for the instant purposes and incorporated into the AIM. The AIM may transform the valence-bond Hamiltonian and metric matrices into matrices represented in antisymmetrized products of the phase-consistent atomic/ionic eigenstates stored in the ASM. These transformed Hamiltonian and metric matrices may be in forms that may be in accord with molecular spectroscopic spin and space designations for diatomic molecules relating particularly to the irreducible representations of the symmetry groups of diatomic molecules. The transformation to this non-orthogonal explicitly antisymmetrized atomic-product representation from the initial valence-bond representation may be accomplished employing the solution of the diatomic Schrödinger equation in the valence-bond representation at arbitrarily large interatomic separations following procedures not disclosed here, and by the use of commonly employed finite point-group symmetry and continuous group symmetry reductions of the diatomic states.

The AIM may further calculate and store for subsequent use the pairwise diatomic interaction Hamiltonian and metric matrices in forms suitable for transformations to orthonormalized spectral-product representations, which transformations are performed in conjunction with the HMM, MMM, and PMM described herein. Such pairwise forms being suitable for summations and assembly into aggregate Hamiltonian matrices for material aggregates as performed in the PMM. The spectrum of corresponding electronic eigenstates for each of these interacting pairs, as well as the transformation matrix from the valence bond to the outer spectral-product representation, may also be stored in the AIM. The AIM may transfer these data upon computer-driven request to subsequent modules described below in which additional calculations and assembly of quantities of interest may be performed. Additional individual computational modules of the AIM are more specifically described as follows.

A Basis Set Repository of the AIM may be a module in the form of storage files for a number of distinct sets of so-called Slater-type atomic-orbital basis sets, including Rydberg extended optimized valence basis sets, Strumian extended valence basis sets, and even-tempered Slater-orbital basis sets, to mention some examples, as obtained from the ASM. The particular forms of these orbital basis sets may be determined by a series of first-principles calculations performed employing the ASM in determinations of the spectral energies and eigenfunctions of atoms of interest, including ground-states, valence-excited states, low-lying Rydberg states, and pseudo-state representations of sums of high-lying Rydberg states and low-lying continuum states. Methods familiar to practitioners of the art may be employed to evaluate the spectral closure afforded by specific basis sets devised, and iterative procedures employed to converge upon values judged to be satisfactory for the instant purposes. The particular radial coordinate powers, exponents, values of orbital angular momenta, and dimension of the representations devised in each case are of significant value and accordingly not disclosed. In selected cases, the Slater basis sets devised may be spectrally compressed to provide one-electron representations of reduced dimensions that nevertheless satisfy the closure conditions employed in evaluations of the un-compressed basis set.

An Integral Evaluation and Storage unit of the AIM may be a module that stores so-called one- and two-electron integrals over the chosen Slater basis functions employing available computer subroutines adopted from the aforementioned SMILES suite, as modified for the instant purposes. These subroutines implement largely standard diatomic algorithms that are known to provide accurate values for the desired integrals. The one- and two-electron integrals evaluated include kinetic energy, electron-nuclear attraction, electron-electron repulsion, and Slater-orbital overlap integrals, all of which may be required in performing electronic structure calculations for molecules and molecular ions. The integrals may be labeled and stored in a manner useful for expediting their retrieval by calls from other modules in the AIM. Additionally, integrals required in evaluation of physical properties other than electronic energies may be evaluated and stored for future use in the AIM.

A Standard Tableau Generator may be a module of the AIM that constructs a set of configurational state functions employing the orthonormal self-consistent field (SCF) or Hartree-Fock orbitals obtained from the ASM represented in Slater basis sets for pairs of atom under consideration and stored in AIM. The tableau module based on aspects of the aforementioned CRUNCH suite may generate a specified set of many electron basis functions commonly designated as standard tableau functions in the jargon of the valence-bond theory of atomic and molecular electronic structure and familiar to those skilled in the arts of electronic structure calculations. These functions may be devised to have particular spin values which relate to one of the possible spin states known to occur in the diatomic pairs under consideration, and may also incorporate the effects of the Pauli Exclusion Principle as they relate to diatomic structure determinations. The atomic pair SCF standard tableau functions may be labeled in machine and/or human readable forms and stored for retrieval by other modules in the AIM for purposes of further calculations which require specification of the basis sets of many-electron functions with given spin values suitable for variational calculations employing the laws of quantum mechanics.

A Diatomic Matrix Generator of the AIM may be a module that constructs many-electron kinetic energy, electronuclear potential energy, electron-electron repulsion energy, overlap, and other matrices in the chosen set of the aforementioned atomic-pair many-electron SCF standard tableau functions. These matrices together providing the Hamiltonian and metric matrices required in solution of the diatomic Schrödinger equation by variational methods in the representation employed as well as other matrices representing physical properties. The matrix generator may be based on aspects of methodology of the aforementioned CRUNCH code suite for such purposes, and may incorporate one- and two-electron integrals provide by methodologies based on the aforementioned SMILES code suite employing code interfaces specifically devised for such purposes.

An Eigensolver/Processor of the AIM may be a module that employs the assembled Hamiltonian and overlap matrices in obtaining variational solutions of the atomic pair Schrödinger equation, possibly employing so-called canonical orthogonalization procedures for this purpose. The diatomic eigenfunctions obtained from the AIM may be described by elements of a transformation matrix that specifies the contributions to a given atomic product pair of the basis of many-electron standard tableau functions employed. The transformation matrix and other relevant information may be tabulated in a standard format for subsequent data access. Phase or sign consistency of the degenerate components of a given diatomic eigenfunction in the atomic pair representation may be assured by use of atomic pair ladder or step operators following the development of the ASM, or by appropriate modification, if required, of the relevant transformation matrix elements which pertain to the diatomic states considered. The diatomic and atomic-pair data stored in the AIM, constructed as indicated above, may be refined from time to time as required. Such refinements in the data stored may be made as the computational methodology for such purposes shows noticeable improvements and the possibility of generating more accurate data sets presents itself Moreover, as additional published experimental data and theoretical calculations of diatomic electronic energies and related information become available the data sets in the AIM may be revised in accordance with the accuracy of this new information. Although the computer architecture of the AIM is fixed at the outset, improvements in its performance may be made from time to time as both hardware and software refinements become available.

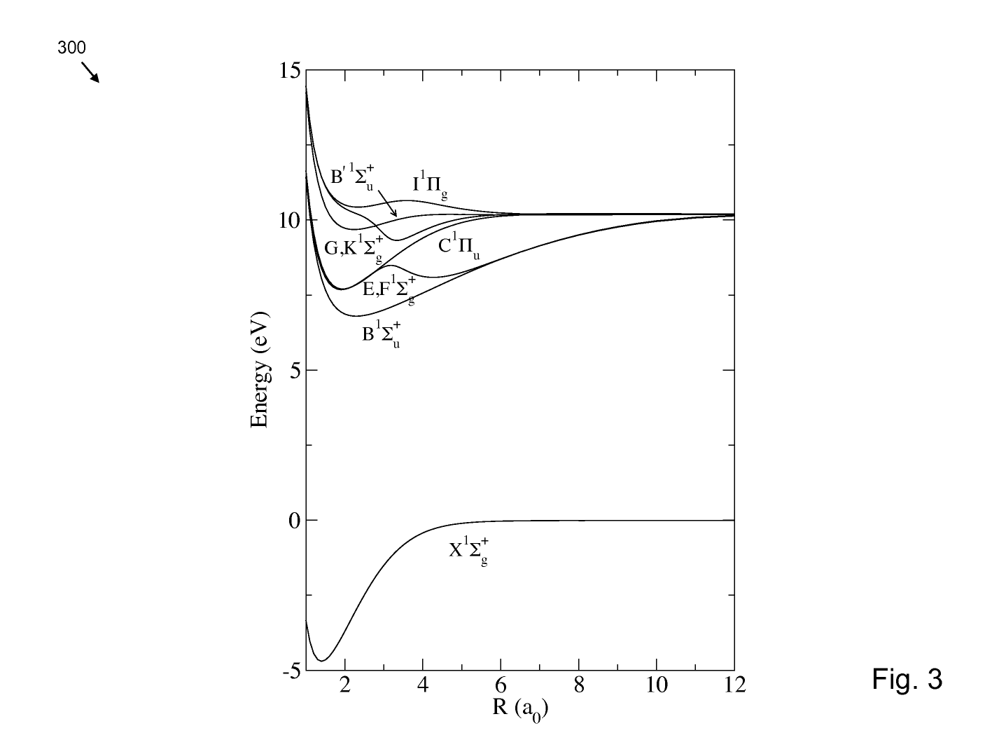

Referring to FIG. 3, depicted are calculated ground and selected excited electronic singlet-state energies of the prototypically important and historically significant hydrogen molecule (H2) as functions of atomic separation (R), obtained from first-principles calculations employing a particular embodiment of the instant AIM devised for such use (M. Ben-Nun, J. D. Mills, R. J. Hinde, C. L. Winstead, J. A. Boatz, G. A. Gallup, and P. W. Langhoff, J. Phys. Chem. A 113, 7687 (2009)). Shown in particular here are potential energy curves for molecular hydrogen that dissociate to the lowest-lying atomic-pair limits of the 1s, 2s, and 2p atomic hydrogen states, employing conventional atomic and molecular spectroscopic notation.

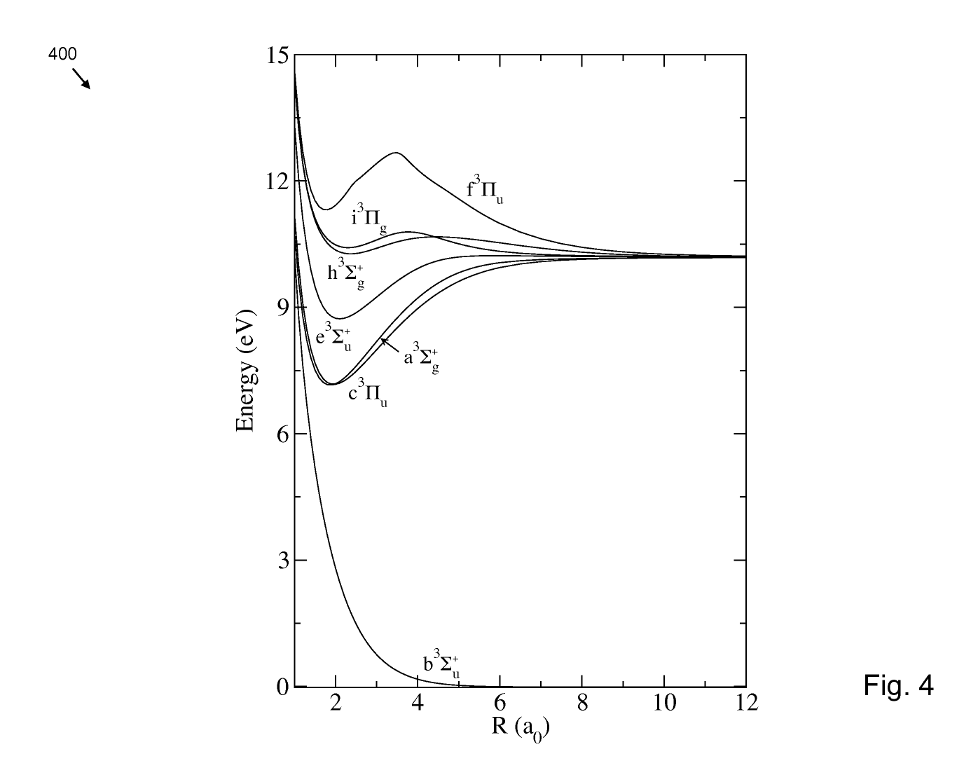

Referring to FIG. 4, depicted are calculated ground and selected excited electronic triplet-state energies of the prototypically important and historically significant hydrogen molecule (H2) as functions of atomic separation (R), obtained from first-principles calculations employing a particular embodiment of the instant AIM devised for such use (M. Ben-Nun, J. D. Mills, R. J. Hinde, C. L. Winstead, J. A. Boatz, G. A. Gallup, and P. W. Langhoff, J. Phys. Chem. A 113, 7687 (2009)). Shown in particular here are potential energy curves for molecular hydrogen that dissociate to the lowest-lying atomic-pair limits of the 1s, 2s, and 2p atomic hydrogen states, employing conventional atomic and molecular spectroscopic notation.

The purpose of the HMM in FIG. 1 may be to transform individual pair Hamiltonian and metric matrices into forms suitable for assembling pairwise additive sums of individual atomic pair-interaction Hamiltonian matrices for a selected aggregate of atoms in predetermined spatial positions employing input from the ASM and the AIM. Such transformation to include rearrangements and summations of the individual irreducible symmetry representation pair Hamiltonian matrices provided by the AIM in forms which provide combined matrices which are spin coupled in terms on atomic pair products, and also may be in forms suitable for spatial rotations employing so-called Wigner rotation matrices. A so-called odometer ordering scheme may be employed for the indices of the combined spin coupled atomic-product matrices which gives rise to well-defined but different orderings of the matrix elements in the different individual aggregate pair-interaction Hamiltonian matrices provided by the AIM. In this odometer ordering scheme, later indices in the aggregate spectral product identifying matrix elements may be run to completion before earlier ones, as described previously herein.

At least two separate procedures may be provided for assembling the atomic pair Hamiltonian matrices in the HMM, both of which take cognizance of the different matrix element orderings of the different aggregate atom-pair interaction Hamiltonian matrices constructed in the spectral-product basis. In cases of manageable-sized aggregate Hamiltonian matrices, which can be accommodated by the addressable CPU or the multi-core nodes of available hardware, the atomic pair matrices required for assembling the entire lower triangle of the aggregate Hamiltonian matrix may be constructed and retained for subsequent use or data transfer. Whereas for arbitrarily large Hamiltonians, the HMM may be designed to operate as a subroutine which can be called by other modules to construct a single matrix element involving two individual aggregate spectral-product basis states, or to construct an entire row or column of an entire aggregate Hamiltonian matrix.

In cases of construction of an entire set of pairwise atomic Hamiltonian matrices by the HMM at atomic pair separations specified by the overall aggregate spatial arrangement, each individual atomic pairwise Hamiltonian matrix may be ordered in so-called last-pair form, in which it is assumed that the two atoms chosen are the last two in the list of atoms appearing in the spectral-product basis. In this last-pair case, the pair-interaction Hamiltonian matrix in the aggregate spectral product basis takes the relatively simple form of a block diagonal matrix having identical subspace pair-interaction matrices down the diagonal. Each of these subspace Hamiltonian matrices has the dimension of the atomic-pair product subspace associated with the pair under consideration, whereas the number of these subspace-dimensioned pair blocks may be determined by the dimension of the entire spectral-product basis less the product of the dimensions of atomic spectral eigenstates of the atoms in the individual pair considered. These circumstances follow from the nature of the odometer ordering convention adopted in the development and the to-to-one mapping between aggregate and atomic-product indices provided. The so-ordered individual pairwise interaction Hamiltonian matrices may be retained for subsequent processing or transfer.

Prior to summing over the individual pair-interaction Hamiltonian matrices in forming the total aggregate Hamiltonian matrix, an assembly performed by the PMM, the pairwise Hamiltonian matrices represented in the aggregate spectral-product basis may be re-ordered by the HMM into their correct orderings in accordance with the odometer ordering convention employed, except for the true last pair of atoms in the aggregate which is already correctly ordered. This re-ordering may be accomplished employing the one-to-one mapping between a pair of integers defining the order of matrix elements as represented in the entire spectral-product basis aggregate and the order of the product of all the integers labeling the individual atomic eigenstates in a given the spectral-product term. Prior to summing the individual pair Hamiltonian matrices in forming the aggregate Hamiltonian matrix, as performed by the PMM, the pair contributions to the sum may be transformed employing appropriate Wigner rotation matrices to orient these interacting atomic pairs in accord with their spatial positions in the atomic aggregate.

When the computational kernel is operating as a subroutine called to provide an individual aggregate Hamiltonian matrix element as a sum over individual pairwise Hamiltonian matrix elements, or to provide a row or column of the entire Hamiltonian, the HMM constructs the individual pairwise Hamiltonian matrix elements which are required in forming the aggregate element, row, or column specified. In responding to this call, the one-to-one mapping between the indices of the aggregate Hamiltonian matrix called, and those of all the atomic states in the aggregate product states involved, provides a basis for the selection of the individual pairwise subspace Hamiltonian matrix elements required in the assembly of the chosen aggregate matrix element, or row, or column thereof. As in the foregoing, this assembly is performed at the aggregate geometry specified by the request made from the calling program operating the computational kernel employing appropriate Wigner rotation matrices to provide the correct angular orientations of the atomic pairs.

The purpose of the MMM in FIG. 1 may be to construct the so-called metric or overlap matrix in individual atomic pair representations and in the aggregate spectral-product basis for a configuration of selected atoms and/or ions in a pre-determined spatial arrangement, and to determine its eigenvalues and eigenvectors. This may be accomplished in a series of sequential computer operations made in accordance with the instructions of a code suite internal to the MMM. These operations may include: (i) calculations of a set of so-called one-electron overlap integrals evaluated using atomic orbital basis-set information for the relevant atoms and ions down-loaded from the ASM or AIM and a set of algorithms devised and programmed for this purpose; (ii) calculation of a preliminary valence-bond version of the many-electron metric matrix for the selected atoms making use of the one-electron overlap integrals for the given atomic spatial arrangement, a list of many-electron valence-bond configurations in accordance with common usage in the art, a list specifying the combinations of configurational functions commonly referred to as standard tableau functions used in valence-bond calculations, and programmed algorithms for assembling the appropriate products of one-electron overlap integrals in forming a many-electron valence-bond representation of the metric matrix; (iii) construction of a matrix to accomplish the transformation of the valence-bond metric matrix to the spectral-product representation, which transformation is obtained from the ordered outer-matrix-product of the individual atomic transformation matrices indicated in the description of the ASM given above which assemble the atomic eigenstates in the form of sums over the appropriate atomic standard tableau functions; (iv) transformation by matrix multiplication of the valence-bond metric matrix to the atomic spectral-product representation employing the constructed transformation matrix, which transformation is supplemented with spin-decoupling from the valence-bond polyatomic representation to the aggregate atomic-product representation of aggregate spin states: (v) determination of the eigenvalues and vectors of the metric matrix in the spectral-product representation by diagonalization at a given atomic aggregate spatial arrangement, and storage of the resulting metric matrix eigenvalues and eigenvectors for subsequent transfer.

The MMM may perform a number of internal consistency checks and manipulations that ensure the calculations provide the desired results, including elimination of eigenstates of the metric matrix which correspond to vanishing or vanishingly small eigenvalues generally associated with linear dependence in non-orthogonal many-electron basis sets. The MMM may transfer the metric matrix eigenvalue and vector data upon computer-driven request to the PMM described herein, in which additional calculations and assembly of quantities of interest may be performed. Although the computer architecture of the MMM may be largely fixed at the outset, improvements to its performance may be made from time to time as both hardware and software refinements become available, or when improved methods for accomplishing the required tasks are developed.

The purpose of the PMM may be to enforce the Pauli exclusion principle for an aggregate of atoms in predetermined positions by constructing a Pauli-principle-corrected Hamiltonian matrix employing input from the HMM and MMM. The PMM may accomplish this in two modes of operation in accordance with the form in which the HMM provides the entire aggregate Hamiltonian matrix as a sum of pairwise additive matrices or provides individual matrix elements or rows or columns thereof. In both cases the goal may be to isolate the totally antisymmetric eigenstates spanned by the spectral product representation pairwise from the non-totally antisymmetric, or non-Pauli, states also spanned by or contained in the representation. The PMM furthermore in the course of isolating the totally antisymmetric subspace of the spectral product representation transforms the total aggregate Hamiltonian matrix, or any component matrix element thereof, to the orthonormal atomic spectral product representation employing input from the HMM and MMM.

In a case where the HMM is directed to provide the complete pairwise aggregate Hamiltonian matrix, the PMM may call the MMM for the eigenvalues and vectors of the entire corresponding aggregate metric matrix or those of the individual pairwise Hamiltonian matrices. These eigenvectors may be employed as the columns of a transformation matrix, which is used in performing a unitary transformation of the entire aggregate Hamiltonian matrix or of individual pairwise Hamiltonian matrices. When the columns of the transformation matrix are ordered from left to right in accordance with a large-to-small ordering of the corresponding eigenvalues of the metric matrix, the resulting matrix product may approach a block-diagonal form in which the upper left-hand block contains the totally antisymmetry eigenstates of the aggregate Hamiltonian, whereas the lower right-hand block will contain the non-Pauli eigenstates of the aggregate Hamiltonian matrix or of individual pairwise Hamiltonian matrices as appropriate. The numerical values of the matrix elements of the off-diagonal blocks of the transformed Hamiltonian matrices give a measure of the degree of convergence to Pauli and non-Pauli eigenstates achieved, with full convergence obtained when the off-diagonal Hamiltonian blocks approach zero. The PMM may pursue an iteration is which larger representations of the metric matrix and its eigenvalues and vectors may be employed until satisfactory convergence is achieved.

In a case where the HMM provides individual matrix elements or single rows/columns of the pairwise or aggregate Hamiltonian matrices, the PMM may adopt a so-called Lanczos approach in isolating the Pauli eigenstates of the pairwise or aggregate Hamiltonian matrices. In this approach, the PMM may provide a test function in the spectral-product representation that is totally antisymmetric in all relevant electron permutations, requiring evaluation of an additional row (column) in the aggregate or pairwise Hamiltonian matrices. The additional Hamiltonian matrix row (column) may be constructed employing this test function as the start vectors in a conventional Lanczos iteration in the space spanned by the aggregate or pairwise spectral-product representation. The matrix elements of the additional row (column) may be formed by projection onto the relevant spectral-product basis, which procedure entails evaluation of an additional row (column) of the aggregate or pairwise metric matrices, provided by the MMM.

The purpose of the ESM module may be to determine the eigenvalues and eigenfunctions of Pauli Hamiltonian matrices as constructed by the PMM. Methods employed for this purpose may be provided by computer libraries of utility programs (BLAS/LAPACK, PETSc/SLEPc) and associated compilers for converting source code into executable codes on available computers of choice. In the event the PMM has satisfactorily isolated the Pauli solutions contained in an aggregate or pairwise Hamiltonian matrix, only that portion of the matrix may be provided by the PMM for diagonalization. In the event the Lanczos approach is employed in the PMM, the energy eigenvalues and eigenstates may be provided directly in the module and the ESM may not necessarily be called.

Referring now to FIG. 2, components and workflow for a prototypical computational application suites is depicted. The applications suite may be designed in this case to determine the stable or meta-stable structures of a selected combination of neutral atoms and/or ions in one or more chosen electronic states, and to predict in this case the associated optical absorption spectra as an aid in verifying the structural predictions through comparison with experimental measurements. The computational kernel of FIG. 1 may provide input information to the applications suite in the form of aggregate electronic energy eigenvalues and eigenfunctions for selected atomic spatial arrangements, or chemical structures, as specified by the applications suite, in this embodiment employing a classical Monte-Carlo sampling algorithm to select trial aggregate chemical structures. Applications suites more generally may perform predictions of specific physical and chemical attributes of a pre-selected set of atomic/ionic constituents employing graphical user interfaces and Perl, Python, or other script-driven instructions to direct the particular computations to be performed. In all such applications, the spectrum of electronic energies and eigenfunctions of the atomic/ionic aggregate under study provided by the instant computational kernel described herein may be central to the predictions. The predictions so obtained may be physically realized in practical applications to scientific, technological, and commercial developments in the forms of new and/or modified materials fabricated in accordance with the guidance of the applications suite employed.

In the embodiment of the applications suite depicted in FIG. 2, the computational kernel may be called repeatedly for the purpose of determining the stable spatial arrangements of pre-selected atoms/ions in the ground electronic states of an atomic aggregate. Such determinations may be performed employing a Monte-Carlo configuration selection algorithm in choosing structures appropriate to the temperature of interest, and evaluating the probability of appearance of a chosen structure on basis of the energy values provided by the kernel. Repeating this over a large number of chosen structures may provide a classical description of the actual structure of the aggregate and of the range of its spatial or vibrational deviation from the lowest energy configuration. The photoabsorption probability, or optical absorption cross section under conditions of vertical excitation, may also be determined in the course of the Monte-Carlo calculations by introduction of the appropriate electronic transition moments between the ground and excited states calculated by the computational kernel upon repeated calls in the procedure. The required transition moments may be provided separately by calls to the indicated transition moment module. The analytical nature of the angular degrees of freedom of the electronic energy expression provided by the kernel, and the convenient pairwise-additive natures of sub-space Hamiltonian matrices involving only N(N−1)/2 scalar separations of the interacting atomic pairs, may make the entire procedure highly efficient.

The computational applications suites may perform first-principles predictions of specific chemical and physical attributes of matter on basis of quantitative information provided by the computational kernel, as well as on additional first-principles information generated in the course of the predictions. The application suites may utilize the computational kernel in realization of the method and may have a largely common structure. This structure may include a computer-graphical or script-based interface for convenient selection and direction of the predictions required, one or more data generation modules which direct the calculations of numerical information required in the predictions not provided by the computational kernel, a calling routine which activates the computational kernel one or more times and accepts through a common data interface output data streams from the kernel in the course of the applications predictions, one or more computational utility programs which perform special purpose operations required in the course of the predictions, and a computer-graphical or data-file output module which displays the results of the predictions in human and/or computer readable forms as desired.

Computer applications software suites may be for the purpose of determining the electronic, magnetic, and other common properties of atomic aggregates in their stable spatial arrangements in the ground electronic states of the entire atomic aggregates. Such properties to include, but not be limited to, (i) electronic charge distributions, (ii) electronic spin densities, (iii) magnetic susceptibilities, (iv) electric and magnetic shielding factors and nuclear magnetic resonance parameters at all atomic sites, and (v) other ground-state physical properties commonly studied both experimentally and theoretically. Such determinations performed making specific use of the largely atomic additive and pairwise-atomic additive natures of the contributing atomic and pairwise-atomic physical properties.

Computer applications software suites may be for the purpose of determining the electronic, magnetic, and mixed electronic-magnetic multipole transition densities between any two aggregate electronic states obtained from the predictions of the computational kernel for selected material aggregates not necessarily in stable spatial arrangements in the chosen electronic states of the atomic aggregates. Such transition densities may provide, but not be limited to, microwave, infra-red, visible, ultraviolet, and x-ray absorption cross sections and related refractive or dispersive properties including, but not limited to, refractive indices and birefringence in the indicated electromagnetic spectral intervals, and mixed electric-magnetic properties including particularly, but not limited to, circular diachronic and related rotatory dispersion parameters. All such determination performed making specific use of the largely atomic additive and pairwise-atomic additive natures of the contributing atomic and pairwise-atomic transition densities.

Computer applications software suites may be for the purpose of determining the electronic potential energy surfaces of colliding and/or potentially reacting binary atomic aggregates, such surfaces to guide the course of the reaction and to determine the yield of the reaction employing commonly employed methodologies for such purposes. Such commonly employed methodologies may include, but not be limited to, quantum mechanical methods based on time-dependent wave functions to determine the course of collision and/or chemical reactions involving moderately sized organic, inorganic, and other compounds, as well as classical Monte-Carlo and/or Molecular Dynamics simulations used particularly in studies of very large atomic aggregates, including particularly, but not limited to, proteins and other bio-compounds, particularly as relates to the design and development of ligand compounds for use in drug design for therapeutic purposes, nano-structures employed in the fabrication of communications and computing devices, and other such large atomic aggregated. Such determinations performed making optimal use of the analytical natures of the angular portions of electronic energy expressions provided by the kernel and the convenient pairwise-additive natures of the total electronic energy involving only N(N−1)/2 interacting atomic pairs.

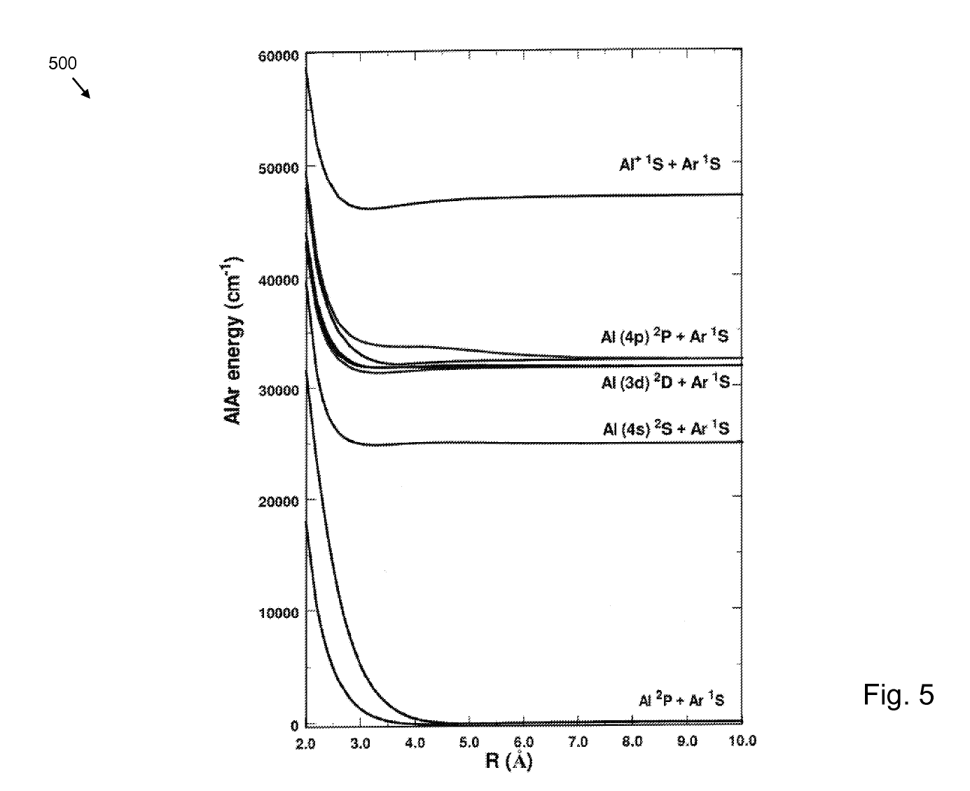

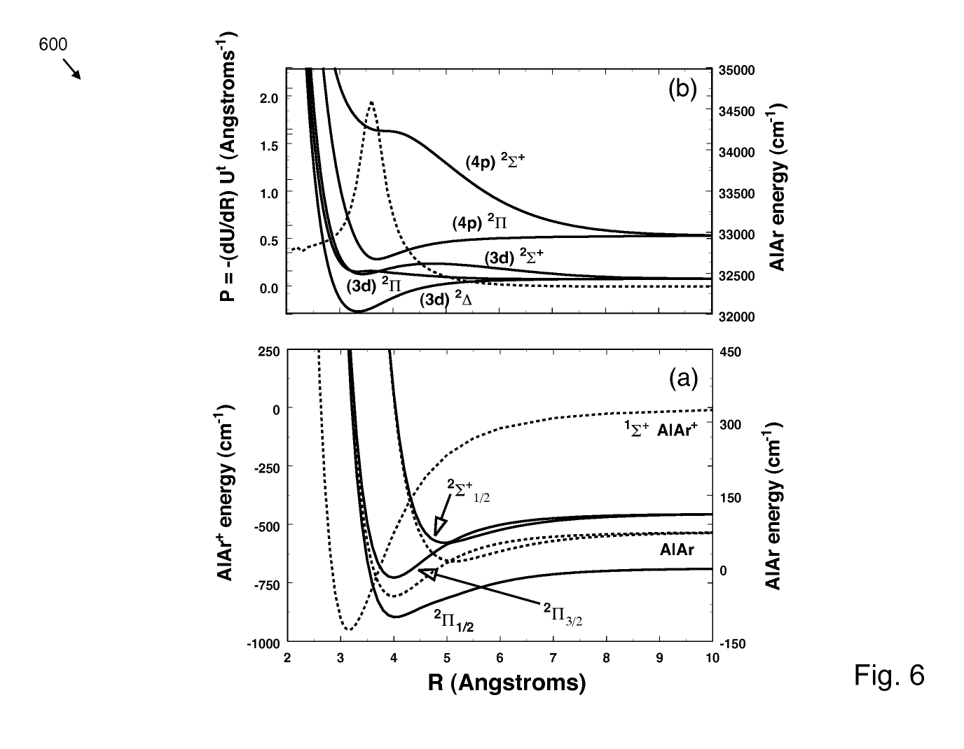

Depicted in FIGS. 5 and 6 are excited electronic energies of the interacting atomic pair AlAr and its cation as functions of atomic separation (R) obtained from first-principles calculations employing an embodiment of the AIM. Shown in particular in FIG. 5 are the potential energy curves for AlAr that dissociate to the four lowest-lying atomic Al states and the ground state Ar atom, employing conventional spectroscopic notation. FIG. 6 provides an expanded view of the calculated ground- and excited-state potential energy curves for the interacting atomic pair AlAr of FIG. 5. The results indicate weak van der Waals bindings in the ground-state curves and the natures of the highly excited states involved in optical excitations: (a) Ground-state ²Π_{1/2}, ²Π_{3/2}, and ²Σ⁺_{1/2} spin-orbit split curves (solid lines) arising from the ²Π and ²Σ⁺ curves (dashed lines) of FIG. 5; (b) Excited-state 3d and 4p AlAr potential energy curves depicting significant configurational mixing giving rise to avoided crossing the potential curves.

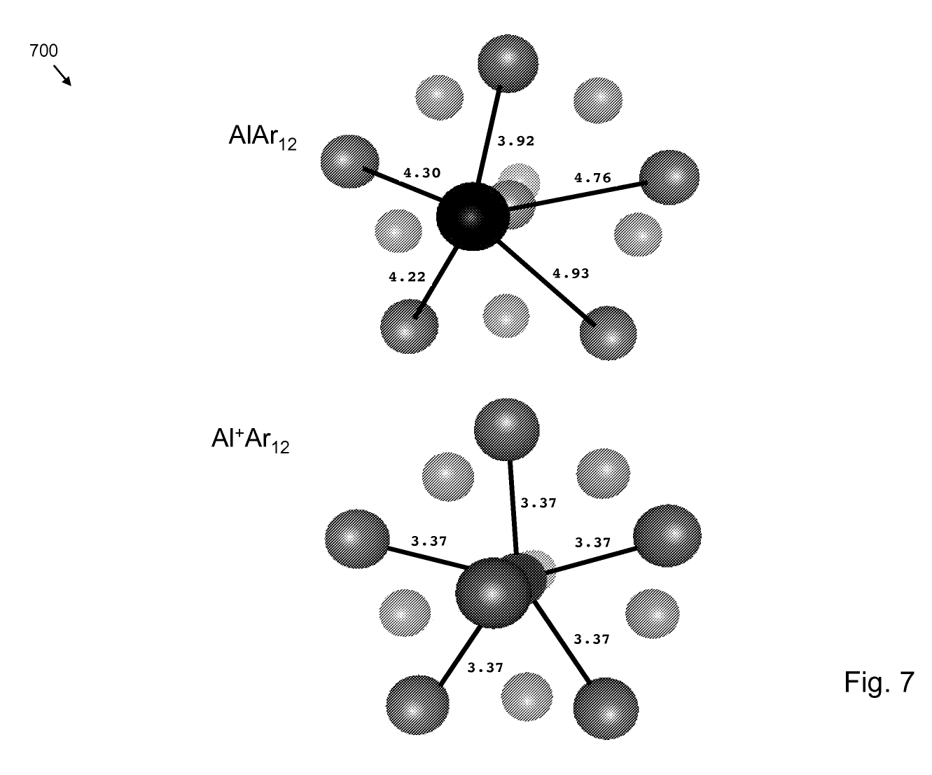

FIG. 7 depicts ground electronic state equilibrium geometries of icosahedral AlAr₁₂ and Al⁺Ar₁₂ clusters at low temperatures (T=30 K) obtained from the electronic potential energy curves of FIGS. 5 and 6 and the cluster energies predicted by the instant computational kernel at spatial arrangements selected by the classical Monte-Carlo sampling applications suite depicted in FIG. 2. The black spheres identify the Al atom and its cation. Nearest neighbor Al—Ar and Al⁺—Ar distances (° A) are indicated to help define quantitatively the different equilibrium geometries or chemical structures of the clusters about which the atoms vibrate. The appearance of the neutral Al atom outside the cluster, as opposed to the appearance of the Al⁺ ion inside the cluster, is a structural subtlety predicted by the instant computational methodology which gives rise to consequences which may be directly verifiable by experiment, (J. M. Spotts C.-K. Wong, M. S. Johnson, M. Okumura, J. A. Boatz, R. J. Hinde, J. A. Sheehy, and P. W. Langhoff, J. Phys. Chem. A 107, 6948 (2003)).

The ab initio QM approaches described herein may be applied to pharmacology. Applications of quantum mechanics (QM) to proteins and other macromolecules have generally been limited to a combination of classical molecular dynamics (MD) and the quantum treatment of the electrons located in a small cluster of atoms actively engaged in chemical bond breaking and formation. However, more accurate predictions of ligand-substrate conformations and binding energies may be useful in drug development. Photoactive proteins, which can provide diagnostic probes of living cells, and can be employed to carry drugs to targeted regions in cells with high specificity, generally require quantum treatments in order to obtain reliable predictions. The instant ab initio QM approach holds the promise of treating the electronic degrees of freedom of entire protein assemblies on a fully quantum level, thereby avoiding the limitations of classical mechanics and QM/MM methods. In this way, refined methods can be devised for identifying potential drug candidates with greater certainty than has been possible, and the ground and electronically excited states of photo-active proteins can be calculated with confidence. A pharmacological applications suite based on the computational kernel may be employed to present candidate drug compounds not just to pathological protein targets but also to a great variety of proteins. In this way, possible toxic or other side effects, which generally are only identified in the course of expensive but required animal and human clinical trials, may be anticipated.

The instant ab initio QM approach to computations may avoid the repeated calculations required in conventional one-molecule-at-a-time approaches to construction of molecular potential energy surfaces. Rather, an approach that entails only atomic and atomic-interaction calculations retained for repeated use may be adopted in the instant invention. Significant speed up may be achieved in construction of ground and excited electronic states in this manner relative to conventional approaches. For example, in conventional approaches each molecular geometry of hexane (C₆H₁₄) requires description of 1,225 mutual pairwise repulsions of all 50 electrons as well as all 1,000 electron-nuclear attractions employing large numbers of spatial orbitals. Many millions of two-electron integrals must be evaluated repeatedly at the many molecular geometry's that are required to adequately describe the possible thermal motions of C₆H₁₄. In the instant ab initio QM approach to any alkane no matter how large, three fundamental atomic pairwise interactions H—H, H—C, C—C may be calculated as functions of atomic separation and retained for repeated use. In this way, the 91 H—H, 84 H—C, and 15 C—C individual atomic interactions in hexane may be rapidly and easily evaluated for any spatial configuration in the absence of any of the time consuming standard computations of the conventional approaches.

The ab initio QM approaches described herein may be applied to medical diagnostics. Real-time microscopic images of the transport of matter in pathological living cells may provide the basis for medical diagnostics of choice for the future. The computational kernel may be employed in a fluorescent diagnostics applications suite for designing new fluorescent probes.

The ab initio QM approaches described herein may be applied to designer propellants. The computational kernel may be employed in a polymer fuels and propellant applications suite. Solid hydrogen is a cryogenic (˜2K) quantum material which, when doped with metal radicals, provides significantly enhanced propulsion performance relative to the conventional liquid LOX-H2 system. Prediction of the structures and properties of doped quantum solids require development of entire new quantum methodology treating electronic and molecular degrees of freedom on a common basis. In an example of the instant ab initio QM approach to propellant design, an all-nitrogen-atom propellant in form of an ionic solid (N3)⁻(N5)⁺ would avoid environment issues with conventional propellants. In another example, a standard approach to Mo(N₃)₇ synthesis may employ low-level DFT calculations (Gamess, Gaussian98) performed on computing facilities, such as Cray T3E, IBM SP/Px and may take 3 man months. The instant ab initio QM approach may employ highly accurate Mo—N and N—N interactions previously determined on supercomputer platforms and the computational kernel developed for desktop work stations to more rapidly calculate molecular structure and related individual molecular properties, as well as bulk physical properties of the condensed-phase aggregate, to high accuracy.

The ab initio QM approaches described herein may be applied to renewable-based fuels. Solar-photon catalyzed production of hydrocarbons from coal combustion products (CO₂, H₂O) may provide an attractive carbon sequestering strategy in terms of fuels ranging from methane to octane (or iso-octane). The computational kernel may be employed in a photochemical reactions applications suite.

The ab initio QM approaches described herein may be applied to nanotechnology. The design of computer chips and other electronic building blocks has moved rapidly to the nano-cluster arena, which requires design methodologies based on the laws of quantum physics. Of particular interest are methods for the atom-by-atom fabrication of nano-structures having specified structural and electronic properties, and the incorporation of single molecules into, between, or on metal and other inorganic materials. The instant computational kernel may be employed in a disordered-solid applications suite.

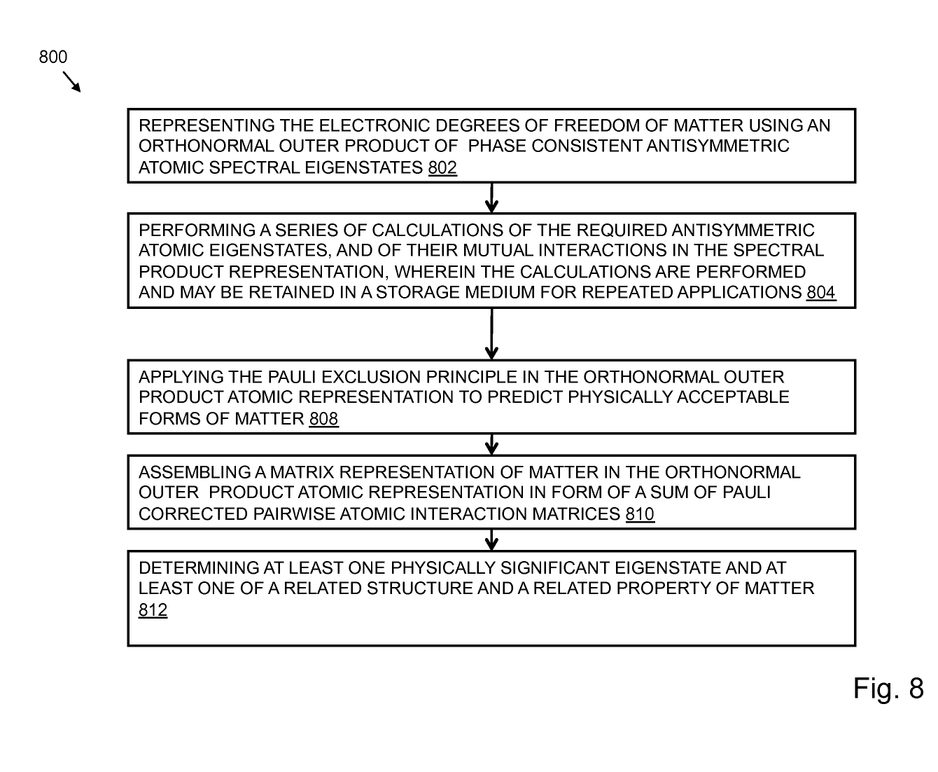

Referring to FIG. 8, a method of first-principles quantum-mechanical predictions 800 may include using a computer to carry out the steps of: representing the electronic degrees of freedom of matter using an orthonormal outer product of phase consistent antisymmetric atomic spectral eigenstates 802; performing a series of calculations of the required antisymmetric atomic eigenstates, and of their mutual interactions, wherein the calculations are performed and retained, such as in a storage medium, for repeated applications 804; applying the Pauli exclusion principle to predict physically acceptable forms of matter 808; assembling a matrix representation of matter in the orthonormal outer product atomic representation in form of a sum of Pauli corrected pairwise atomic interaction matrices 810; and determining at least one physically significant eigenstate and at least one of a related structure and a related property of matter 812.

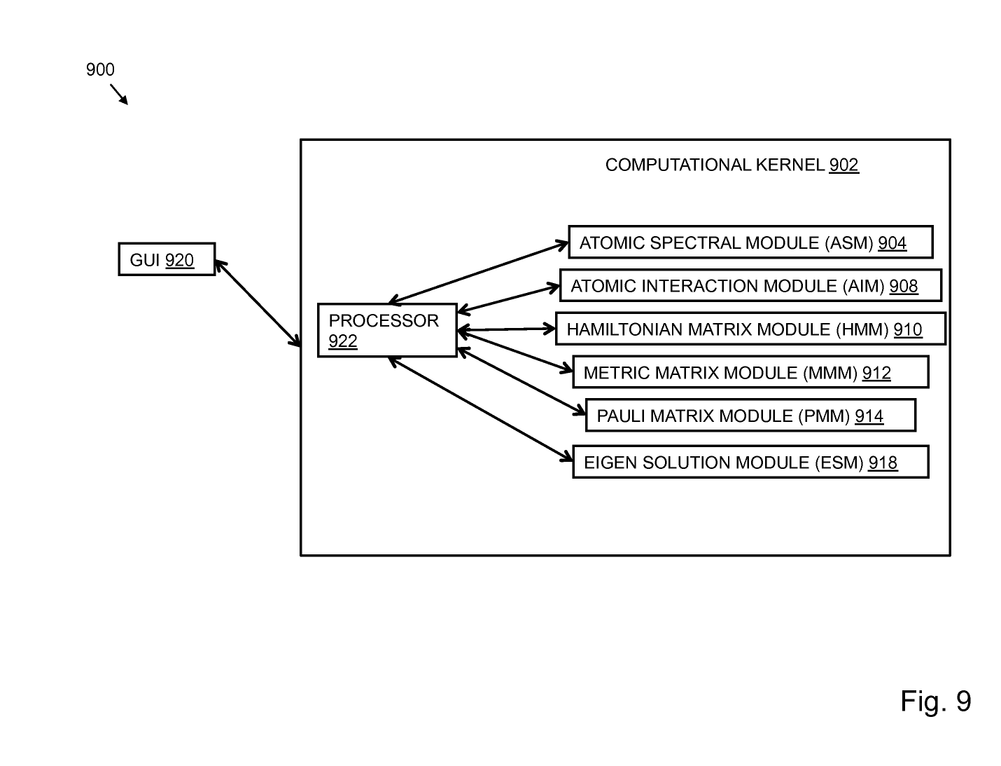

Referring to FIG. 9, a system for first-principles quantum-mechanical predictions 900 may include a computational kernel 902 comprising interconnected modules 904-918 that perform separate functions comprising numerical calculations, data processing, data storage and data retrieval as appropriate, wherein the functions may be accessed through a graphical user interface 920 and may be under the control of a processor 922; and wherein the kernel provides a spectrum of electronic energies and eigenfunctions in a designated standard form for a given spatial arrangement of selected atoms and ions which make up a molecule or other form of matter. The modules may include one or more of: an Atomic Spectral Module (ASM) 904, an Atomic Interaction Module (AIM) 1008, a Hamiltonian Matrix Module (HMM) 910, a Metric Matrix Module (MMM) 912, a Pauli Matrix Module (PMM) 914, and an Eigen Solution Module (ESM) 918.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A computer-based method of first-principles quantum-mechanical predictions, executed on a computational system including a processor, comprising:
representing the electronic degrees of freedom of matter using an orthonormal outer product of phase consistent antisymmetric atomic spectral eigenstates, thereby producing an orthonormal outer-product atomic representation;
performing a series of calculations of the required atomic eigenstates, and of the mutual pairwise interactions of the subject atoms in the orthonormal outer-product atomic representation, wherein the results of the calculations are retained in a storage medium for repeated applications;
applying the Pauli exclusion principle in the orthonormal outer-product atomic representation to predict physically acceptable forms of matter;
assembling a matrix representation of matter in the antisymmetric subspace of the outer-product atomic representation in the form of a pairwise sum of individual atomic interaction matrices; and
determining at least one physically significant eigenstate and at least one of a related structure and a related property of matter.

2. A system for first-principles quantum-mechanical predictions, comprising:
a computational kernel comprising interconnected modules that perform separate functions comprising numerical calculations, data processing, data storage and data retrieval as appropriate, wherein
the functions are accessed through a user interface and are under the control of a processor; and
wherein the kernel provides a spectrum of electronic energies and eigenfunctions in a designated standard form for a given spatial arrangement of selected atoms and ions which make up a molecule or other form of matter.

3. The system of claim 2, wherein the modules comprise one or more of: an Atomic Spectral Module (ASM), an Atomic Interaction Module (AIM), a Hamiltonian Matrix Module (HMM), a Metric Matrix Module (MMM), a Pauli Matrix Module (PMM), and an Eigen Solution Module (ESM).
